(19) United States
(12) Patent Application Publication
(10) Pub. No.: US 2022/0215346 A1
(43) Pub. Date: Jul. 7, 2022

(54) RECRUITING METHOD AND SOFTWARE

(71) Applicant: RecruiterPM LLC, Evanston, IL (US)

(72) Inventors: Daniel MILLER, Chicago, IL (US); Sarah YEVEROVICH, Chicago, IL (US)

(21) Appl. No.: 17/420,809

(22) PCT Filed: Sep. 21, 2020
(86) PCT No.: PCT/US20/51801

§ 371 Date: Jul. 6, 2021

Related U.S. Application Data
(60) Provisional application No. 62/906,205, filed on Sep. 26, 2019.
(60) Provisional application No. 63/045,515, filed on Jun. 29, 2020.

(51) Int. Cl. G06Q 10/10; G06Q 10/06

(52) U.S. Cl. CPC G06Q 10/1053; G06Q 10/06393; G06Q 10/06316

(57) ABSTRACT

A system for managing hiring for a company, including a jobs database, a candidate database, a dashboard module, a key performance indicators and statistics module, a contest module, a revenue analytics module, a global knowledgebase, a task module, a payments module, a live platform, a vendor module, and an onboarding module that are in electronic communication with a user interface, the system being stored on non-transitory computer readable media. A method of managing hiring for a company using the system.

### BACKGROUND OF THE INVENTION

### 1. Technical Field

The present invention relates to methods of recruiting and hiring job applicants. More specifically, the present invention relates to software for recruiting and hiring job applicants.

### 2. Background Art

Agency recruiters or internal recruiters work with a company to fill jobs within that company, generally by reviewing resumes or searching for qualified job candidates. They review a candidate's qualifications, can negotiate salaries with a company, and assist job candidates with employment issues.

Owners and managers are constantly micro-managing recruiters due to fear of losing the hire or taking too long, yet they are micro-managing statistics and not thinking to look at daily tasks that bring one the ability to hit key performance indicators. Recruiting managers need transparency into the step by step process taken by recruiters to find suitable talent instead of just focusing on performance around phone calls, phone screens, or submittals. The real focus is how one gets to the phone call with the right candidate and that is why there is a need to direct attention on resource analytics, research/sourcing tasks and the ability to “project manage” the recruiting process.

Many companies use Applicant Tracking Systems (ATS), resume databases, job postings, websites such as Indeed or LinkedIn, but do not use the important recruiting principles of project management and planning. While other industries have specific project management tools, the recruiting industry does not, and must use software that is focused on ATS, interview management and scheduling, and candidate sourcing.

Researchers, sourcers and recruiters are required to conduct constant research in order to source talent for job openings. Daily research can consist of finding candidates at top competitors, creating job postings, searching LinkedIn in a multiple of ways utilizing Boolean techniques and search filters, searching for candidates on CareerBuilder and Monster and using a multitude of other resources.

Remembering what the recruiter did and which resources were used and effective is very hard because each of these tasks become very redundant and easily one or a multitude of the steps can be forgotten. Recruiters who are managing 5 to 20 open roles cannot remember what steps they took in each role. This has been an industry issue for way too long. In every other industry, there are many project management tools, but for the recruiting industry, there are many programs to find candidates (LinkedIn, Monster, Indeed, etc.) and manage the interview and onboarding process (Applicant Tracking systems like PCRecruiter, Taleo, Bullhorn, etc.), but there are no tools that project manage the tasks that go into the research and search process.

Therefore, there is a need for a system for effectively managing job recruiting.

### SUMMARY OF THE INVENTION

The present invention provides for a system for managing hiring for a company, including a jobs database, a candidate database, a dashboard module, a key performance indicators and statistics module, a contest module, a revenue analytics module, a global knowledgebase, a task module, a payments module, a live platform, a vendor module, and an onboarding module that are in electronic communication with a user interface, the system being stored on non-transitory computer readable media.

The present invention also provides for a method of managing hiring for a company, by a recruiter receiving a new role, turning on an open job record in a system for managing hiring for a company stored on non-transitory computer readable media, adding in day to day tasks in the system, displaying open jobs or archived jobs in the system, providing a candidates database in the system, providing dashboards in the system, providing customized key performance indicators and statistics in the system, providing contests in the system, providing a global knowledgebase in the system, providing payments in the system, and providing revenue analytics to a user on a user interface.

### DESCRIPTION OF THE DRAWINGS

Other advantages of the present invention are readily appreciated as the same becomes better understood by reference to the following detailed description when considered in connection with the accompanying drawings wherein:

FIG. 1A is a flowchart of information in the system of the present invention, and FIG. 1B is a diagram of components of the system;

FIGS. 2A-2F are views of a job interface, FIG. 2A shows an entry interface, FIG. 2B shows an open jobs list, FIG. 2C shows job details and projects, FIG. 2D shows an archived jobs list, FIG. 2E shows an active contracts/temp contractors page, and FIG. 2F shows a payment information and costs page;

FIG. 3 is a view of an interface of tasks;

FIG. 4A is a view of an interface of key performance indicators, and FIG. 4B is a view of an interface with an expanded metrics view;

FIG. 5A is a view of an interface of tasks, and FIG. 5B is a view of a deep dive of management reports;

FIG. 6 is a view of an interface of a global knowledgebase;

FIG. 7 is a view of an interface for creating permissions;

FIG. 8A is a view of an interface of a dashboard for recruiting firms, FIG. 8B is a view of an interface of a dashboard for staffing firms, FIG. 8C is a view of an interface of a dashboard for candidates/contractors 1099, and FIG. 8D is a view of an interface of a dashboard for hiring managers/companies;

FIG. 9 is a view of an interface providing candidates;

FIG. 10 is a view of an interface of a global dashboard;

FIG. 11 is a flowchart of movement of money within a payments module;

FIG. 12A is a view of an interface for creating live reports, FIG. 12B is a view of an interface for creating live reports, FIG. 12C is a view of live contests, FIG. 12D is a view of live reports, and FIG. 12E is a view of leadership boards;

FIG. 13 shows a schematic of paying contractors;

FIG. 14A is a landing page of a department overview, FIG. 14B is a view of the vendor overview selection, and FIGS. 14C-14D are views of management reports;

FIG. 15 is a view of departments and users;

FIG. 16A shows a view of setting up interviews, FIG. 16B shows views of interview pipelines, and FIGS. 16C and 16D show a candidate/client interview template;

FIG. 17A is a view of a vendor module, FIG. 17B is a view of default job access, FIG. 17C is a view of inviting vendors, FIG. 17D is a view of invitation history, and FIG. 17E is a view of invitation history;

FIG. 18 is a view of an onboarding module;

FIG. 19 is a view of a staffing firm dashboard;

FIG. 20 is a view of an open jobs section;

FIG. 21 is a view of an active contracts/temps section;

FIG. 22 is a view of temp/contract hire details;

FIG. 23 is a view of paying freelancers, contractors, and temps

FIG. 24A is a view of a job overview details page and FIG. 24B is a view of job overview details with search page;

FIG. 25 is a view of client feedback and a feedback score;

FIG. 26 is a view of call lists;

FIG. 27 is a view of resumes;

FIG. 28 is a view of adding in a phone screen or interview;

FIG. 29 is a view of tracking activities of candidate conversations;

FIG. 30 is a view of moving candidates through the interview process on the job detail project screen;

FIG. 31 is a view of a window that allows the candidates to be in the loop of all interview processes via email notifications;

FIG. 32 is a view of creating text message marketing campaigns;

FIG. 33 is a view of a window for creating follow ups;

FIGS. 34A, 34B, 34C, 34D, 34E, 34F, 34G, 34H, 34I, and 34J are views of email within the system;

FIGS. 35A-35B are views of text messages within the system;

FIG. 36A is a view of a main page of scorecards, FIG. 36B is a view of adding a scorecard, and FIG. 36C is a view of changing a scorecard;

FIG. 37A is a view of different themes for career pages, FIG. 37B is a view of adding information in an about us section, FIG. 37C is a view of adding information in a core values section, FIG. 37D is a view of adding information about benefits, FIG. 37E is a view of adding information about careers, FIG. 37F is a view of adding information about job details, FIG. 37G is a view of a finished career page, and FIG. 37H is a view of a job listed on a career page; and

FIG. 38A is a view of a global search, FIG. 38B is a view of a contact search, FIG. 38C is a view of options for a smart search, FIG. 38D is a view of search results, FIG. 38E is a view of search results, FIG. 38F is a view of filters, and FIG. 38G is a view of candidate comparison.

### DETAILED DESCRIPTION OF THE INVENTION

The present invention generally provides for a computer software system and method for managing tasks that recruiting teams do daily, project managing these tasks, and analyzing and compiling data based on tasks used. The system is stored on non-transitory computer readable memory, such as a hard drive or in the cloud.

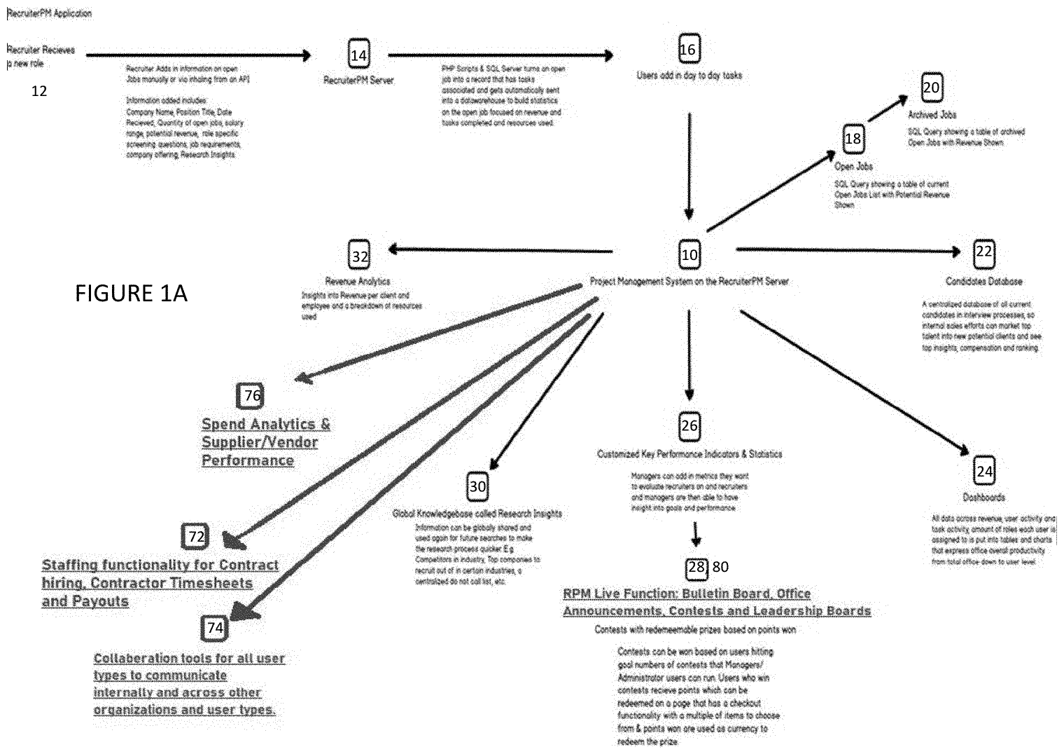

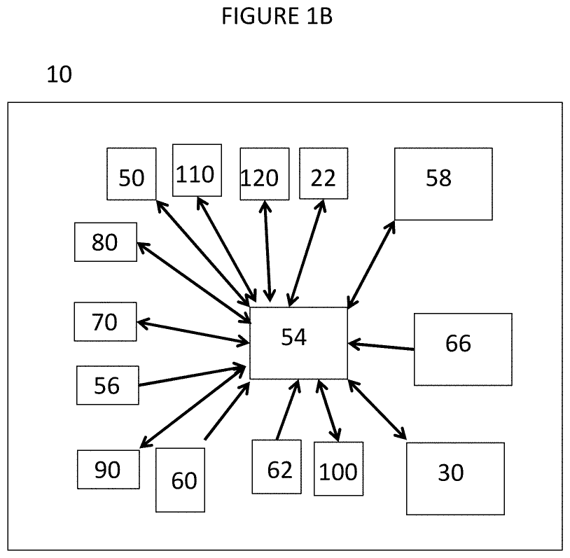

FIG. 1A shows the general flow of information in the system, shown at 10. In the method of managing hiring for a company of the present invention, a recruiter receives a new role 12, the system 10 turns on an open job record 14, and users add in day to day tasks 16. The system 10 can display open jobs 18 or archived jobs 20, provide a candidates database 22, provide dashboards 24, provide customized key performance indicators and statistics 26, provide contests 28, provide a global knowledgebase 30, and provide revenue analytics 32. The analytics are provided to both recruiters and other users of the system 10 in addition to management staff. The information is all integrated into analytics from tasks, statistics, daily information added into the system 10 and open and archived job project data.

FIG. 1B shows the components of the system 10 for managing hiring for a company, wherein a jobs database 50, a candidate database 52, a dashboard module 56, a key performance indicators and statistics module 58, a contest module 60, a revenue analytics module 62, a global knowledgebase 30, a task module 66, a payments module 70, a live platform 80, a vendor module 90, and an onboarding module 100 are in electronic communication with a user interface 54. Jobs are analyzed for performance based on days a job is open. The tasks in the task module 66 are analyzed and sent into the analytic module 62 for managers to analyze the stats of resources used by each employee and resources used for each client account. The statistics module 58 feeds the contest module 60 data in order to figure out who won the contest based on statistics.

The computer system 10 and method can be a complete hiring system for any company, whether it be an agency who hires for external companies or organizations who are building internal departments. Focus for companies can be on open jobs at a department level. The computer system 10 and method allows for all hiring needs to be managed via a vendor management and collaboration system where agencies, hiring managers, as well as candidates and 1099 contractors or employees can collaborate on a hiring process, e-sign contracts and documents and then handle payments and print out end of the year compensation and payment records for taxes (shown at 74). Due to the lack of funds sometimes to front the money for contract employees, staffing and recruiting agencies are able to pay 1099 contractors via a credit card and get charged a fee. Companies can also pay and keep track of timesheets on 1099 contractors via the computer system 10 (shown at 72), which auto populates the contractor payroll to get paid out on the computer system 10.

The user interface 54 can be a screen on a tablet, smartphone, smartwatch, computer, or laptop.

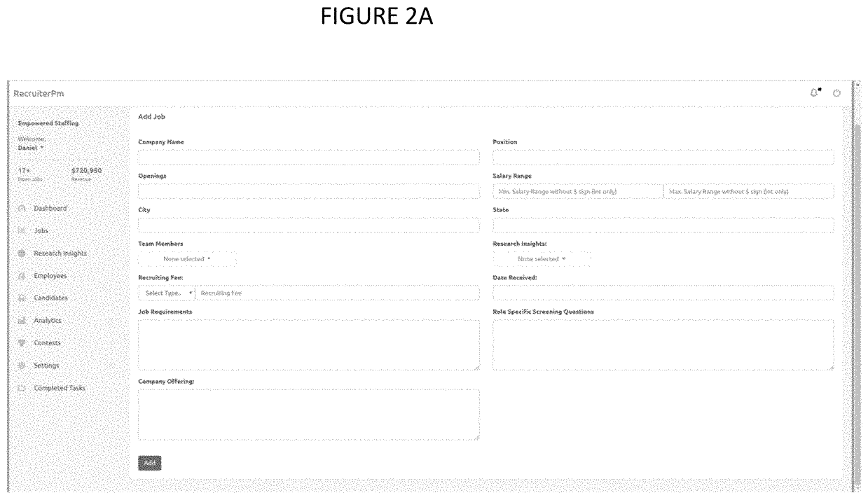

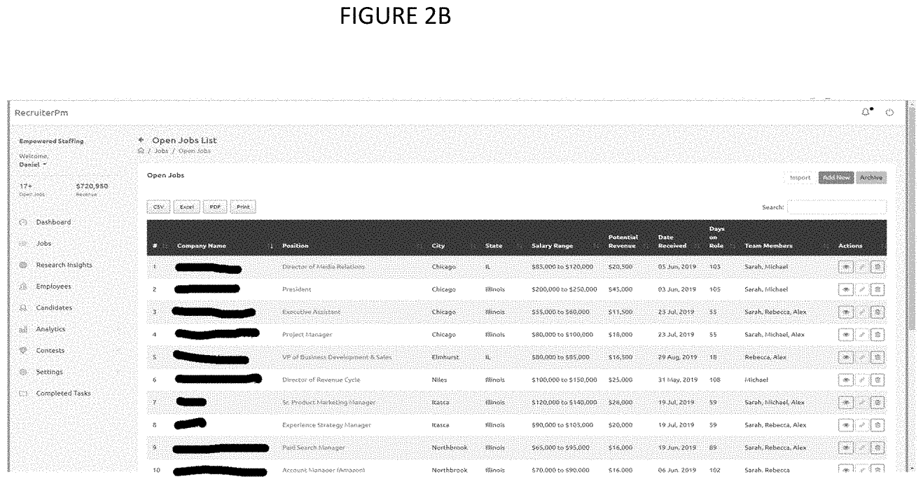

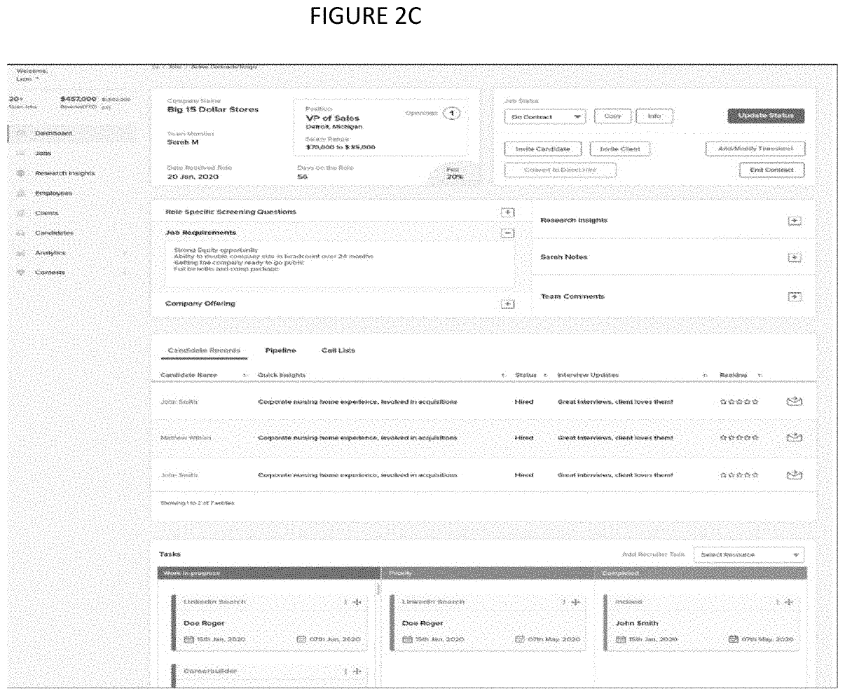

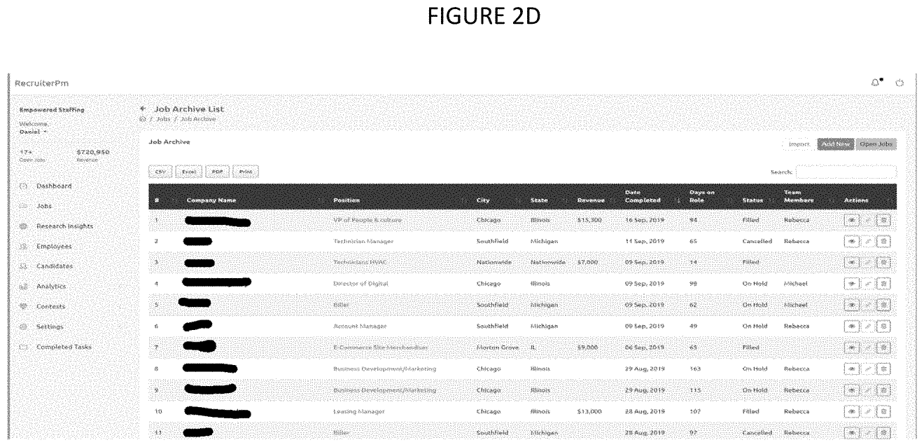

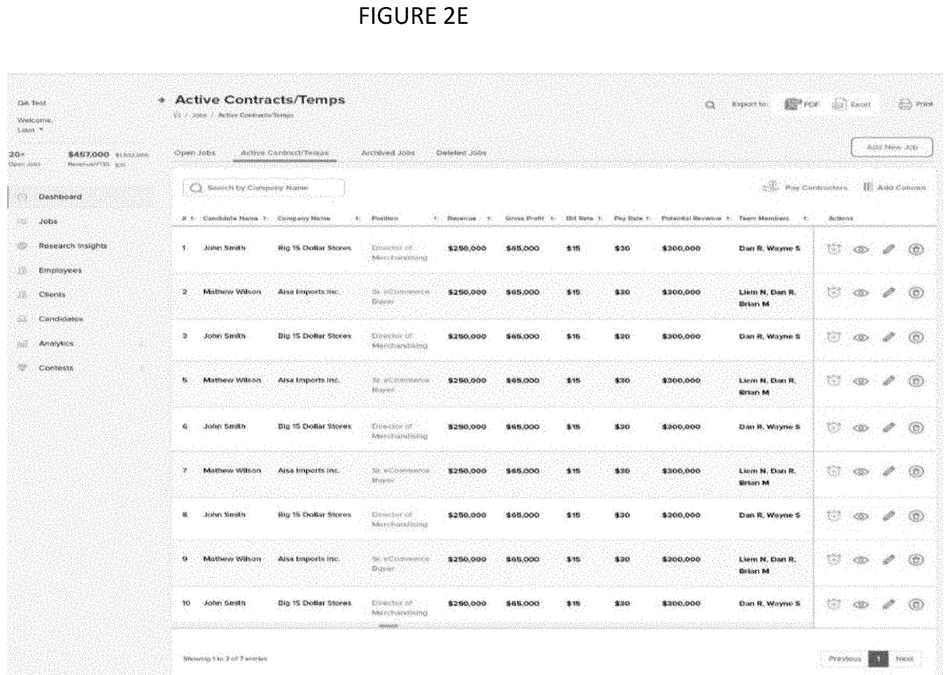

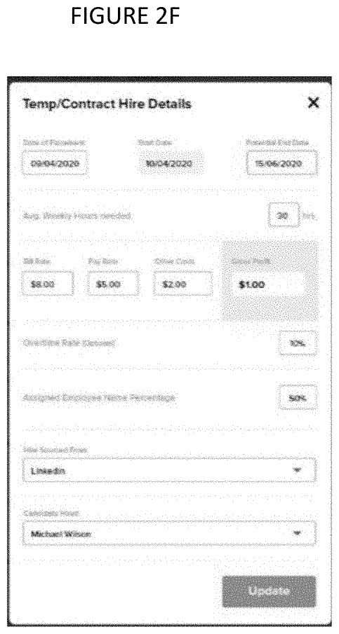

New jobs can be created 14 and open jobs 18 and archived jobs 20 can be displayed in the user interface 54 with a jobs database 50 shown in FIGS. 2A-2C. Once a recruiter creates a new job or imports a job into the system 10 with a job entry interface (FIG. 2A), it aggregates the jobs that are active into an open jobs interface (FIG. 2B) that consists of a table via SQL database. Information can be added regarding the job such as, but not limited to, company name, position title, date received, quantity of open jobs, salary range, potential revenue, role specific screening questions, job requirements, company offering, and research insights. Job details and a project page can be displayed for each open job (FIG. 2C). PHP scripts and SQL server 14 turn an open job into a record that has tasks associated and gets automatically sent into a data warehouse to build statistics on the open job focused on revenue, tasks completed, and resources used. An opens jobs interface available with an SQL query shows a table of all open jobs 18, potential revenue earned, assigned employees, and key job information. This centralized list allows all users to see the open jobs 18 and stay on top of what the team is working on. Archived jobs 20 can also be viewed as a table with revenue in the interface shown in FIG. 2D with an SQL query. A view of active contracts/temp contractors page can also be created with the ability to pay contractors, as shown in FIG. 2E. Payment information and costs can be added in when it is calculated how much contractors spend, as shown in FIG. 2F.

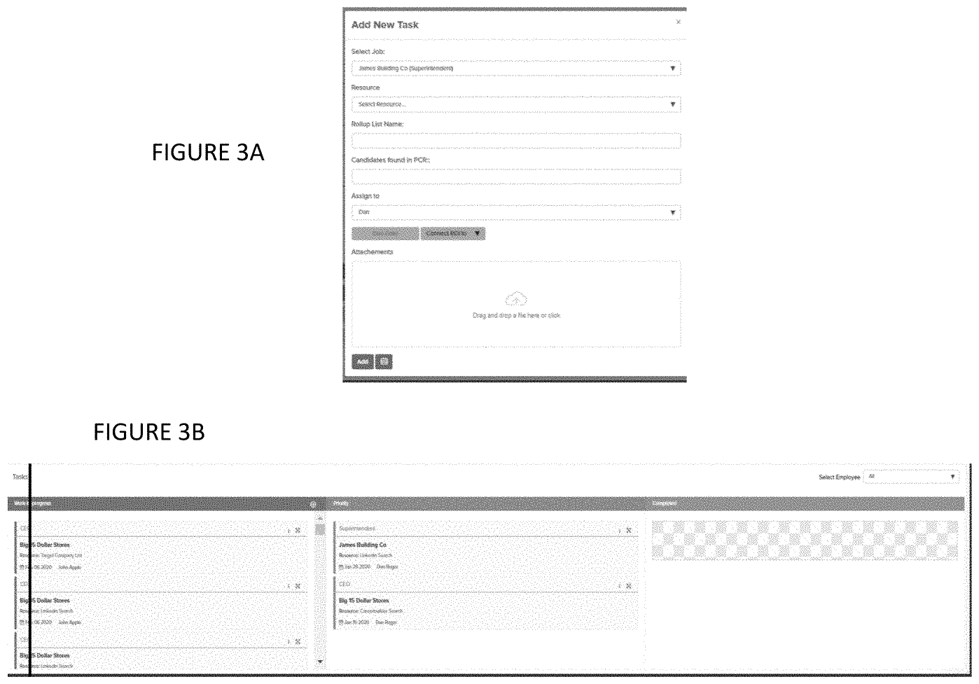

Day to day tasks 16 are created utilizing a task management system (task module 66) that is customized based on the resources a recruiting team uses, with an interface shown in FIGS. 3A-3B. The system 10 allows for managing which tasks were completed on every open position and it then builds a database on the backend that brings the manager a high level overview of which resources are used and how effective each recruiter and resource is. Every job opening is treated as an individual project. With each open job a user can manage which employees are assigned, tasks (that can be added as in FIG. 3A and which can be assigned to certain employees, and can be viewed by order of priority and status as in FIG. 3B), information about the open role (screening questions, job requirements, quantity of openings, company information and job title, etc.), team collaboration via messaging, top candidates being considered for the position, the results that came from the tasks being completed, and finally the revenue earned from each open job or the cost of hiring the job.

This system 10 automates which tasks should be auto assigned to users and it allows managers to stay on top of which recruiting tasks were completed across each resource every use has access to including: LINKEDIN®, CAREERBUILDER®, MONSTER® and many more. The server allows users to create and customize tasks used by the office. Everything is modular based on the recruiting team's needs.

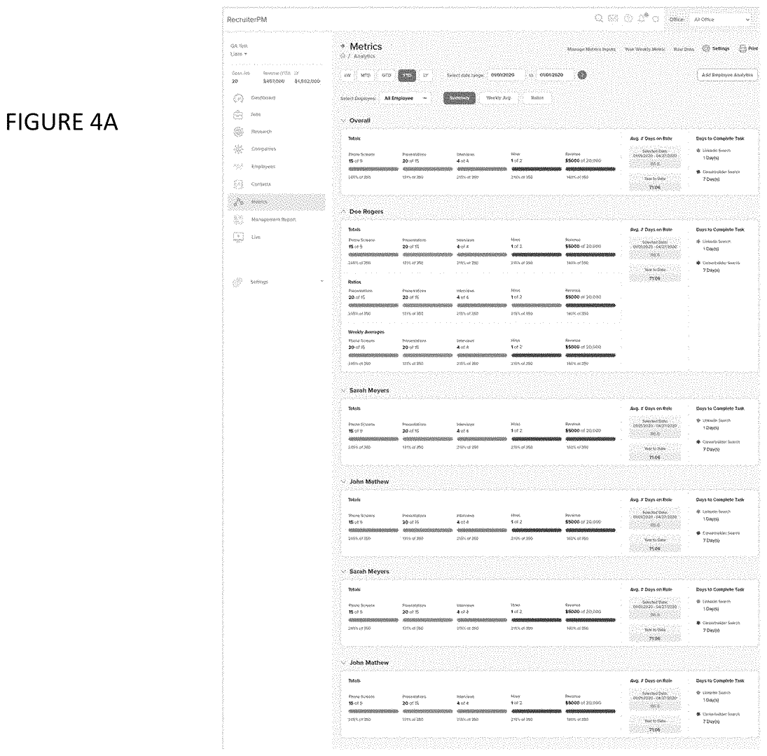

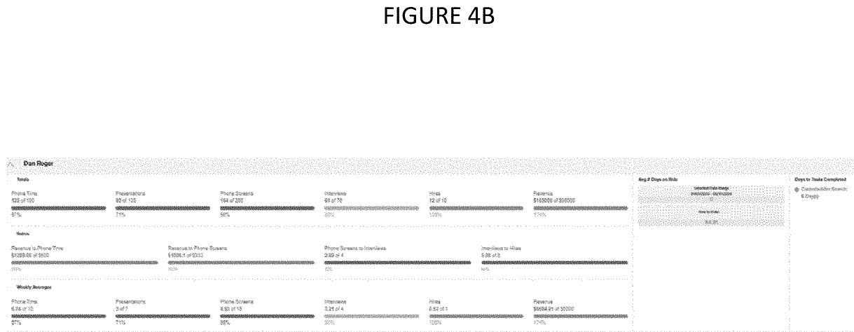

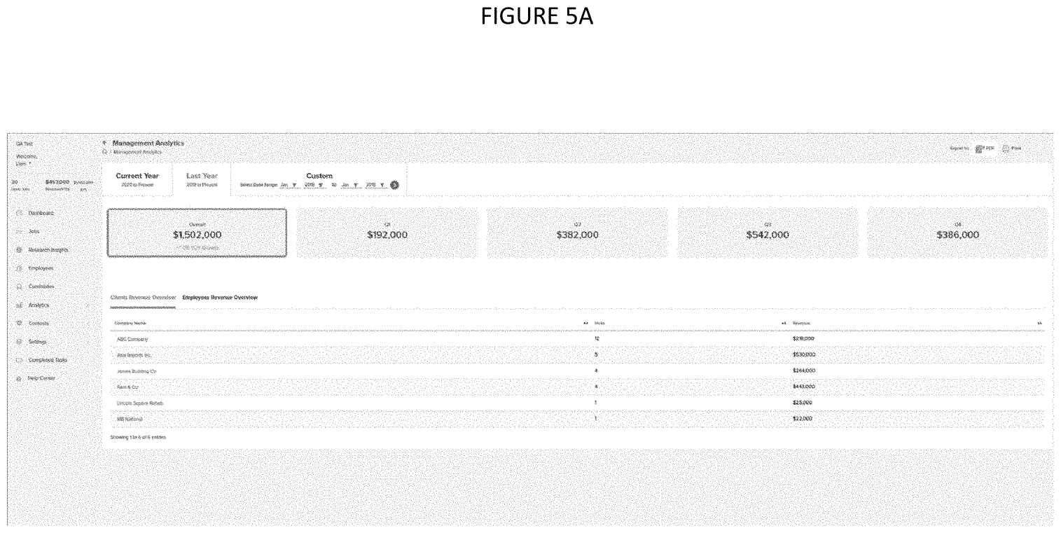

This system 10 also enables managers to create customized key performance indicators 26 and measure them against goals with a key performance indicator module 58. All goals are showcased in a dashboard that builds diagrams showing totals, averages and ratios on each employee. Measure metrics that are customizable based on office, including phone time, presentations, submittals, interviews, hires, placement values, and ratios to understand how much the user is earning every hour they are on the phone or for any other metric they decide to add in (shown in FIG. 4A). FIG. 4B shows an expanded view of metrics where ratios and weekly averages can be seen in addition to totals of KPIs and metrics that are being analyzed.

Based on goals, the user is able to build contests 28 with contest module 60 and when certain numbers are hit, contest winners receive points which can be redeemed for prizes on the system 10 (an interface can have a checkout functionality with multiple items to choose from and points won are used as currency to redeem the prize). This point system can also be used as a rewards system outside of the contest functionality. Managers can award points to users outside of the statistical data and contest functionality and users can redeem the points for prizes on the platform. This system 10 also brings insight into management about how much the user is earning per client, how much of each resource was used for that client for each role hired, and an overview of how each recruiter is doing with a breakdown of revenue and resources used to make the hires. The system 10 works for any companies who are hiring, even if they are not recruiting or staffing agencies. Dashboards can be tailored to different companies, and companies who hire can have a platform view that is focused on showing data around spend, vendor spend and performance (shown at 76), contract employees, and hire and timesheet data.

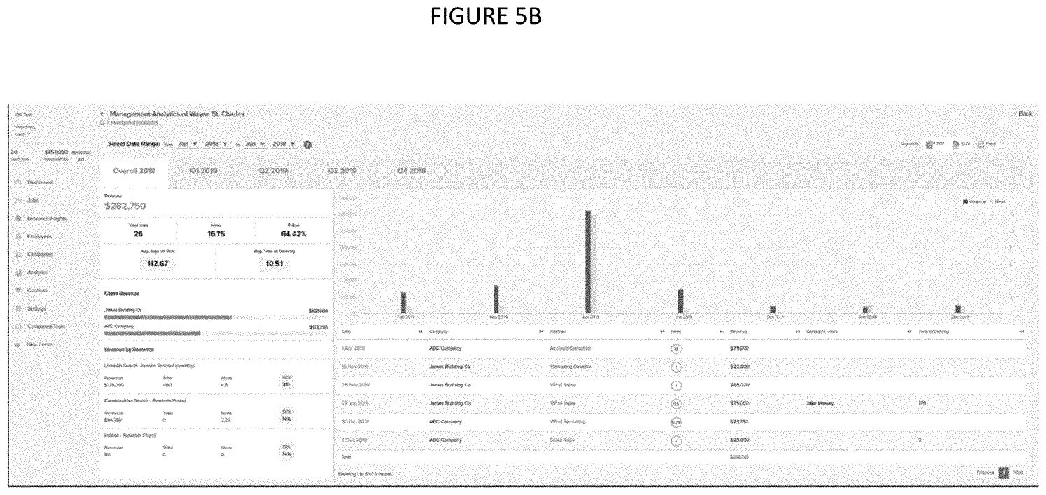

Tasks that are created by users with a task module 66 are then brought into a data warehouse which then allows managers to view a table consisting of each client, how many resources were used and tasks associated with each client account in addition to showing revenue generated with each client account (shown in FIG. 5A, with a deep dive view shown in FIG. 5B that can show details of any client, department, company, or employee). There is also a breakdown of revenue brought in under each employee and the resources each employee used, so users can understand the return on investment on each employee, resource, tasks and client account.

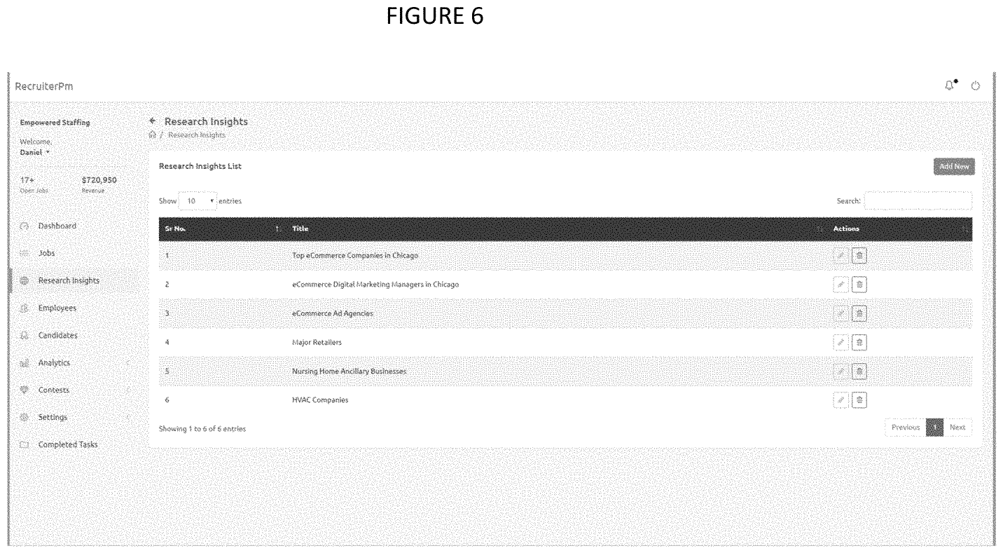

There is a shared knowledgebase in the system 10, i.e. a global knowledgebase 30, shown in FIG. 6, where information can be globally shared and used again for future searches to make the research process quicker. In a recruiting firm, many times recruiters have to remember who the top competitors are in a multitude of industries or other pieces of information to properly find the right talent. Having a shared knowledgebase that team members can contribute to and can attach to a job opening, allows recruiters to streamline research processes by having readily available information that can be applied to the research process instantly without having to recall where one kept their master competitor lists. This can be used by competitors in industry, for top companies to recruit out of in certain industries, or for a centralized do not call list. This global knowledgebase 30 can also be fed information by the system 10 creator to be used by a multitude of separate entities and offices, to share information globally among accounts, that can be of use for recruiting firms. The global knowledgebase 30 essentially spreads knowledge among the industry to help other offices with research processes.

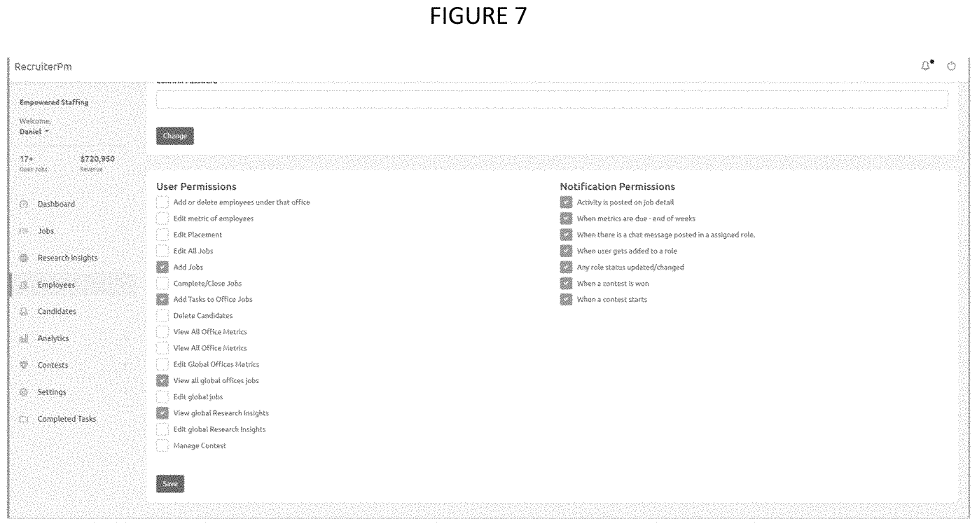

Users can be associated with a user type that gives certain levels of permissions and administrators of the company account can change which permissions users have access to and what types of notifications pop up including: job activity, metric inputs, when jobs are closed or assigned to team members and more. FIG. 7 shows an interface for creating permissions.

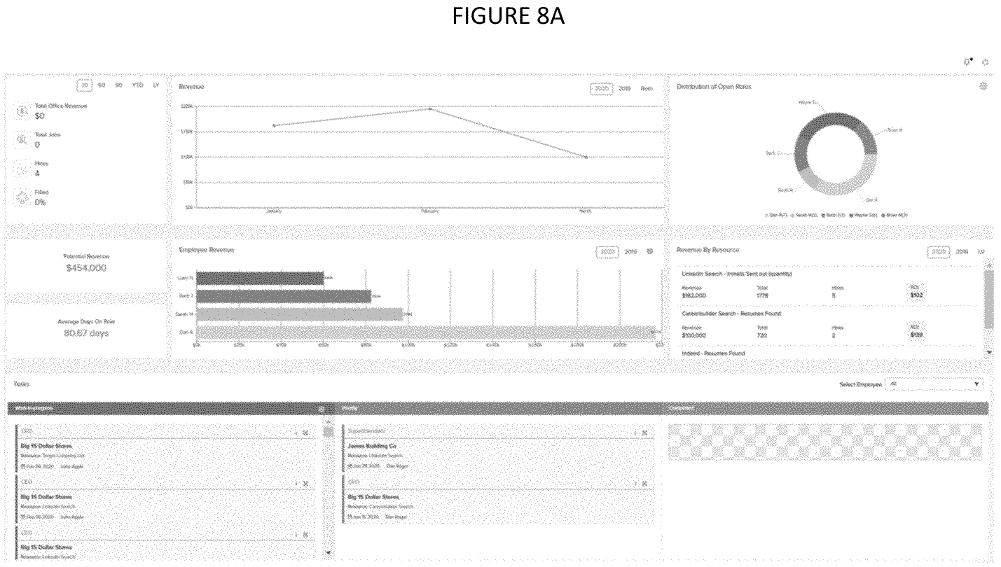

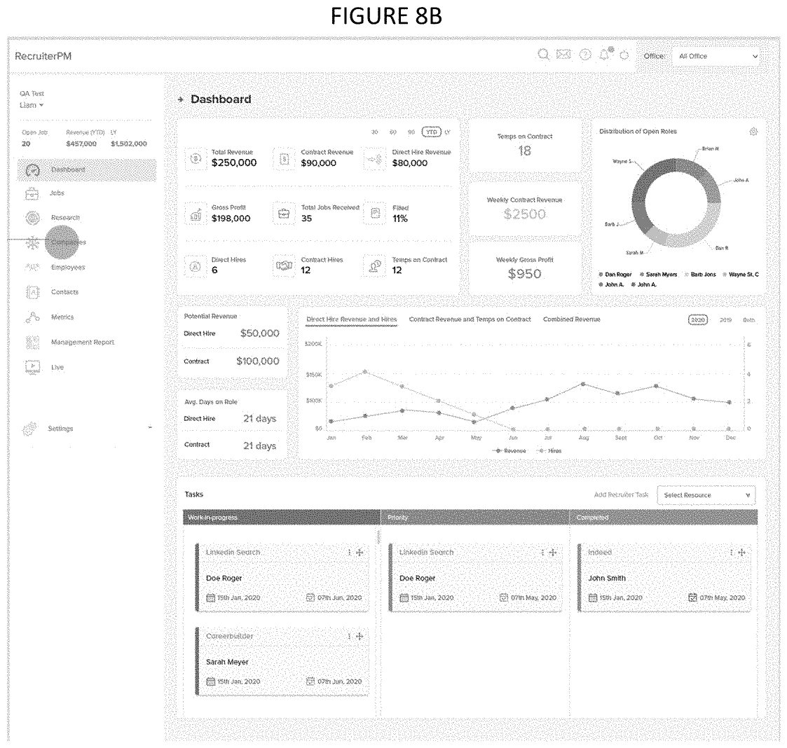

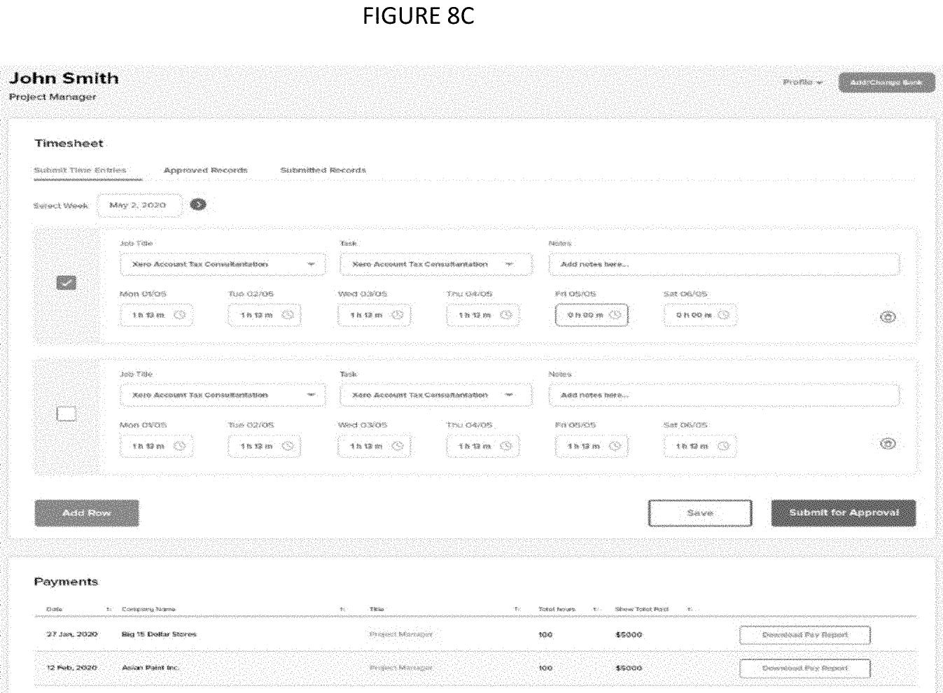

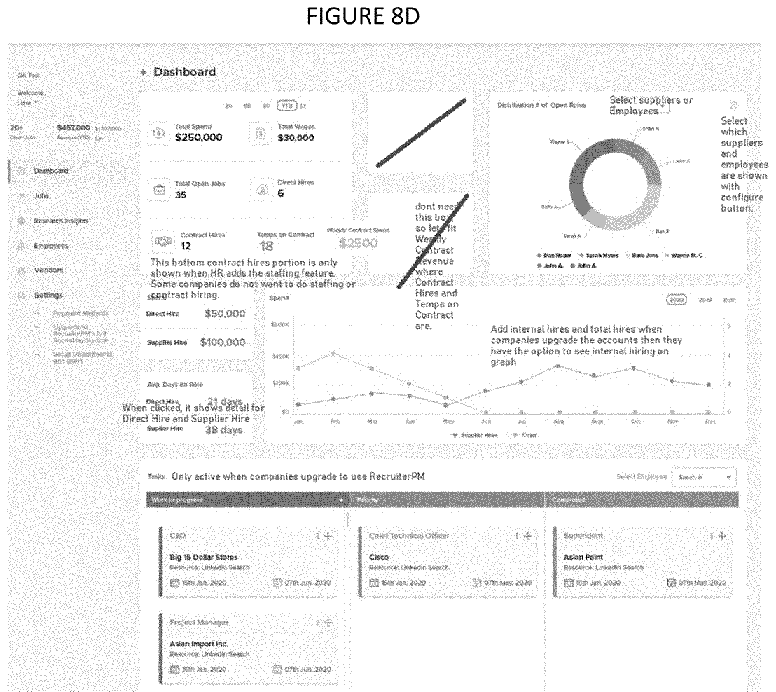

Dashboards 24 created with a dashboard module 56 are available to all user types that include an interactive drag and drop task list where a user can prioritize, add, and drag tasks to complete tasks on open jobs (shown in FIGS. 8A-8D). On an administrator dashboard, administrator user types have the ability to see how much revenue or spend they are producing over time periods with elegant charts and graphs, provided by revenue analytics module 62. They also have a snapshot of team performance, the potential revenue per each team member, contests being run, the overview of all tasks being completed in the office and what employees have yet to do including overall office statistics gathered from job details. Administrators also have the option to keep revenue and spend information private when using the application around users that are not privy to such information. Dashboards 24 can be created custom for different individuals, such as for recruiting firms (FIG. 8A), staffing firms (FIG. 8B), candidates/contractors 1099 (FIG. 8C), or hiring managers/companies (FIG. 8D).

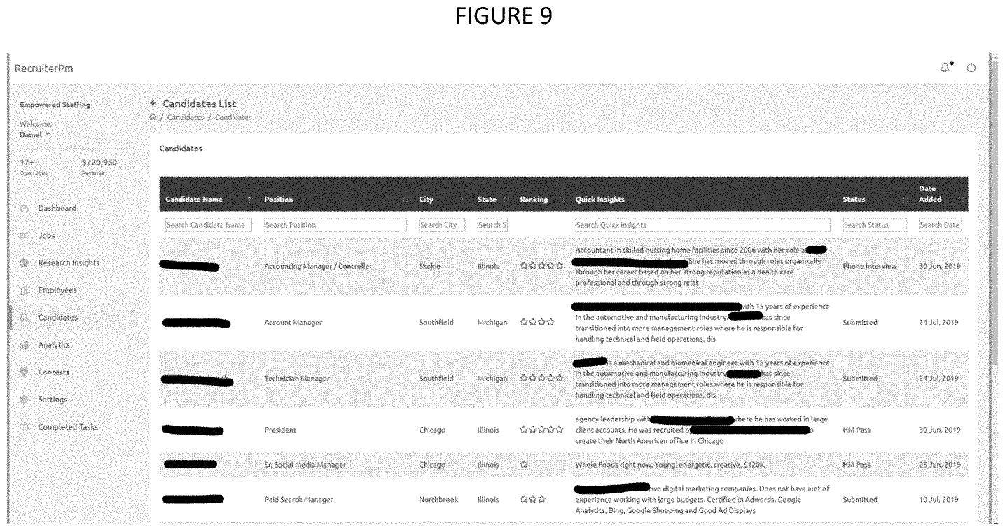

In many recruiting offices, it is the role of the sales team to market top candidates back into the market to find new potential clients and help top talent find their next position. The system 10 keeps a record of every candidate added to the interview processes across client accounts, top reasons why they are the best and then builds a database that is searchable for individuals to quickly find the top candidates in interview processes. Partner integrations for artificial intelligence search and job matching can be used to automate the internal search process for candidates. FIG. 9 shows user interface 54 that provides the candidates from candidates database 22.

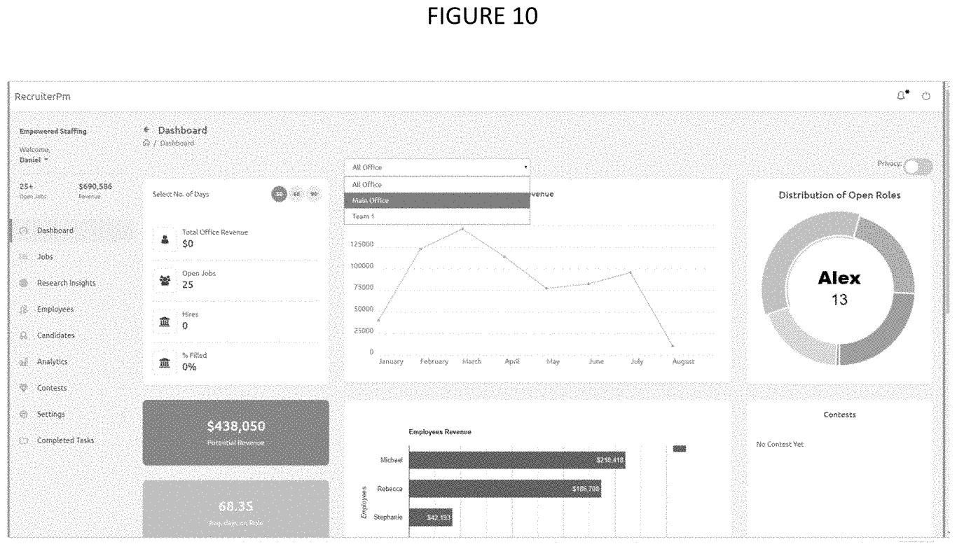

If there are multiple locations or offices in one organization, the system 10 allows users to choose global options to incorporate statistics into global user dashboards and allow users to gain access and insight from other offices and jobs being worked on, shown in FIG. 10. This allows users to via office specific data or global office data based on customized options.

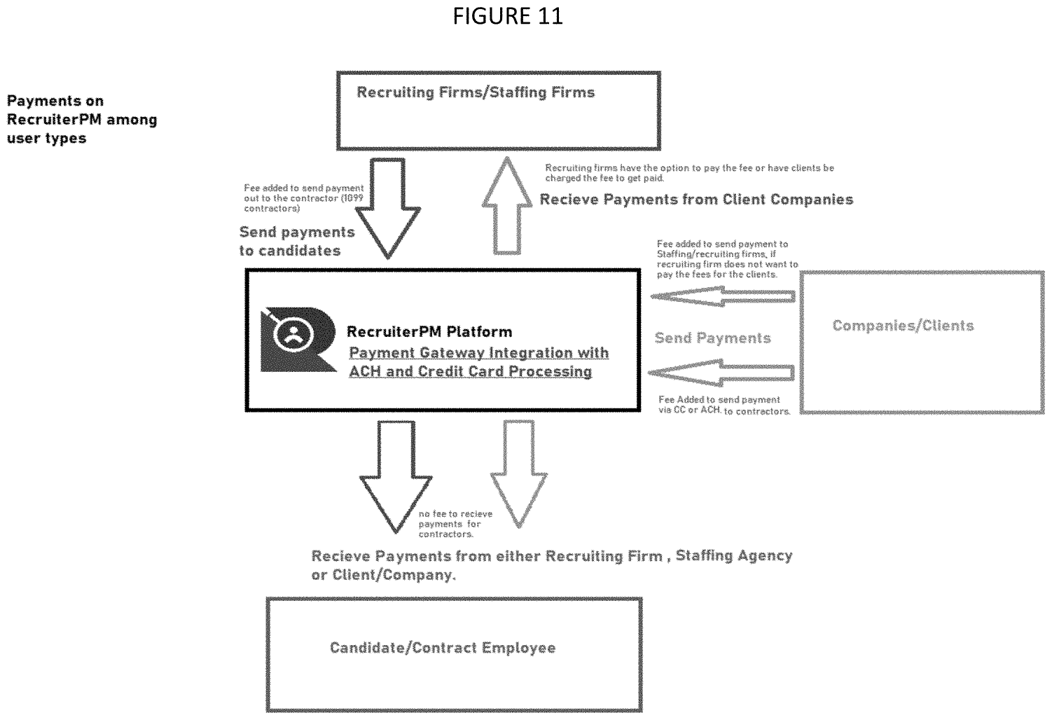

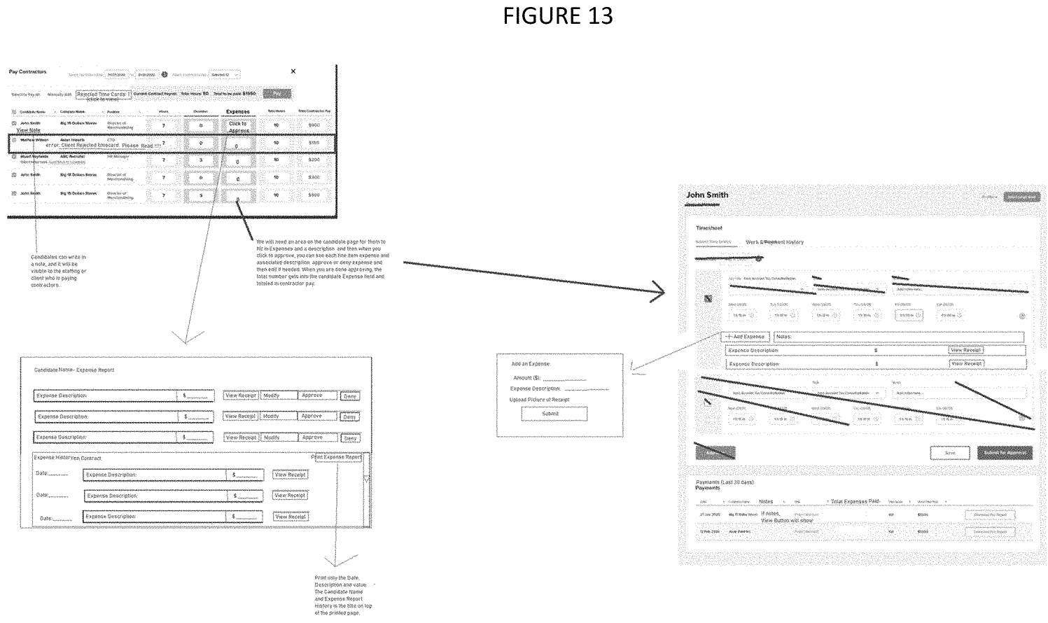

The system 10 can include a payments module 70 that allows recruiting firms, staffing agencies, and companies to pay each other via ACH or credit cards. This allows both companies who hire the ability to pay out and manage spend, while also offering them a new way to pay vendors and contractors based on their own payment terms set by their credit card or via an easy ACH transfer on the system 10. Recruiting firms/staffing firms can send payments to candidates and receive payments from client companies through the payments module 70. Companies/clients can send payments through the payments module 70 to staffing/recruiting firms or contractors. 1099 Contractors can receive payments both from recruiting firms and staffing agencies as well as any companies who hire 1099 contractors on the platform, and the payment is sent directly into their bank. The fee to pay contractors can be incorporated into the fees of the staffing, recruiting, and hiring companies, so 1099 contractors get paid without incurring fees. FIG. 11 shows the flow of payments between user types. FIG. 13 shows a schematic of paying contractors. Candidates can write in a note which is then visible to the staffing or client who is paying the contractors. Expenses can be filled in with a description, and when “approve” is clicked, each line item expense and associated description can be viewed, and the expense can be approved, denied, or edited if needed. When approving is finished, the total number goes in the candidate expense field and totaled in contractor pay. Expense reports can be printed with only the date, description, and value. The candidate name and expense report history can be in the title on top of the printed page.

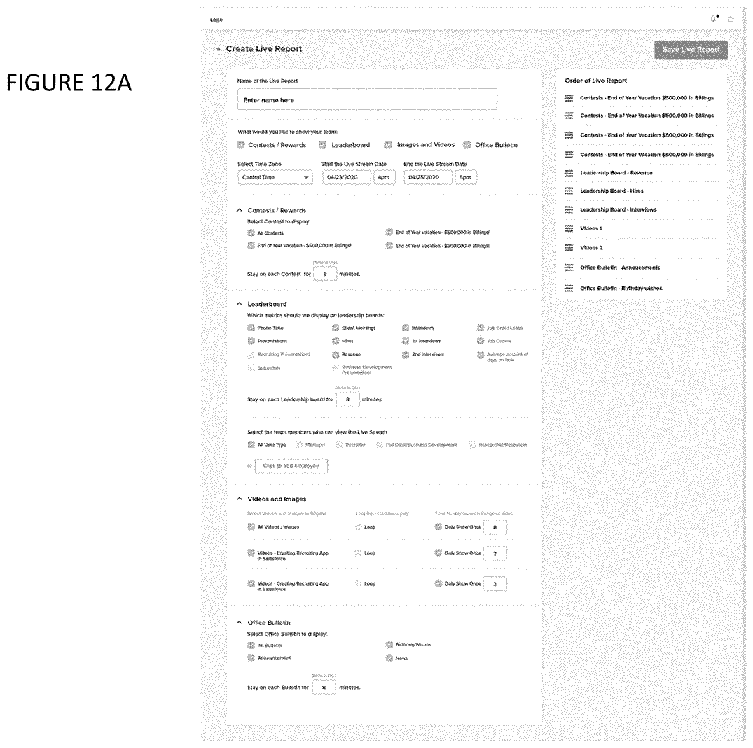

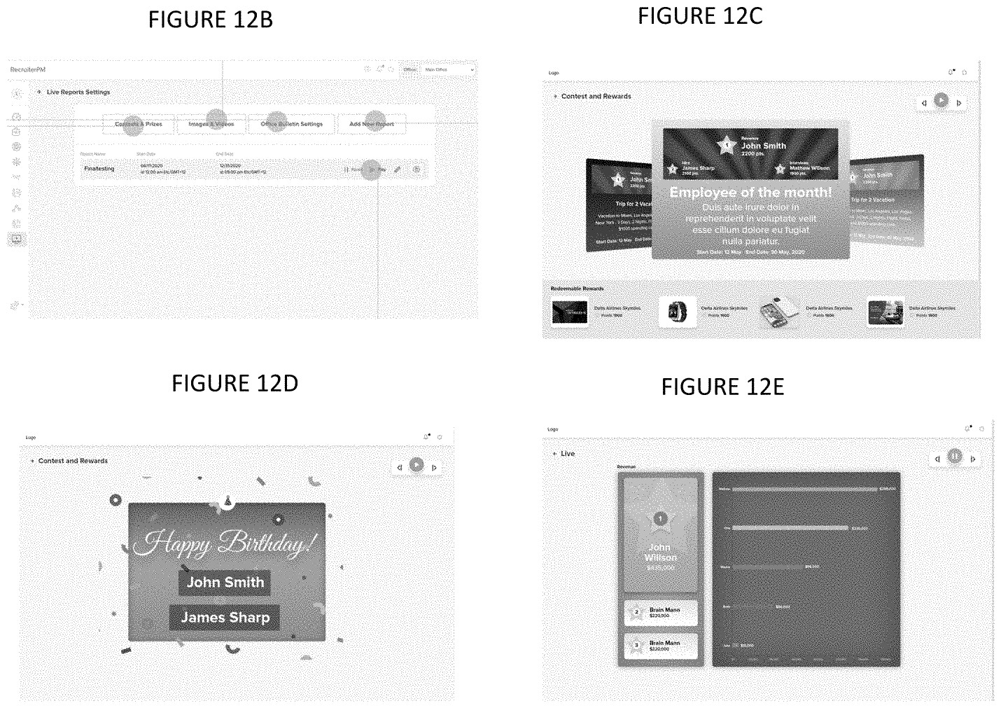

The system 10 can include a live platform 80 component where managers can save channels of information with live data to display to the office (FIGS. 12A-12B). Utilizing the contests and KPI/metrics data, live contests and leadership boards to display across the company can be created (shown in FIGS. 12C-12E).

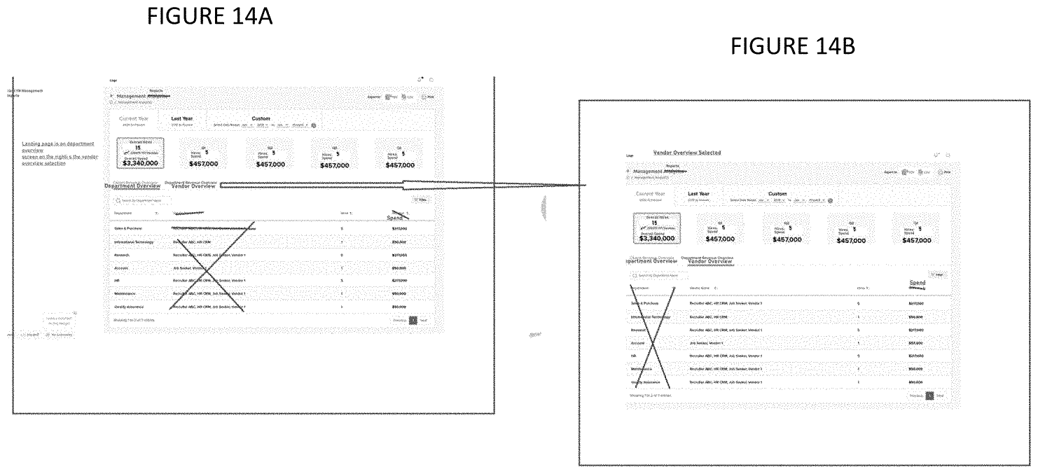

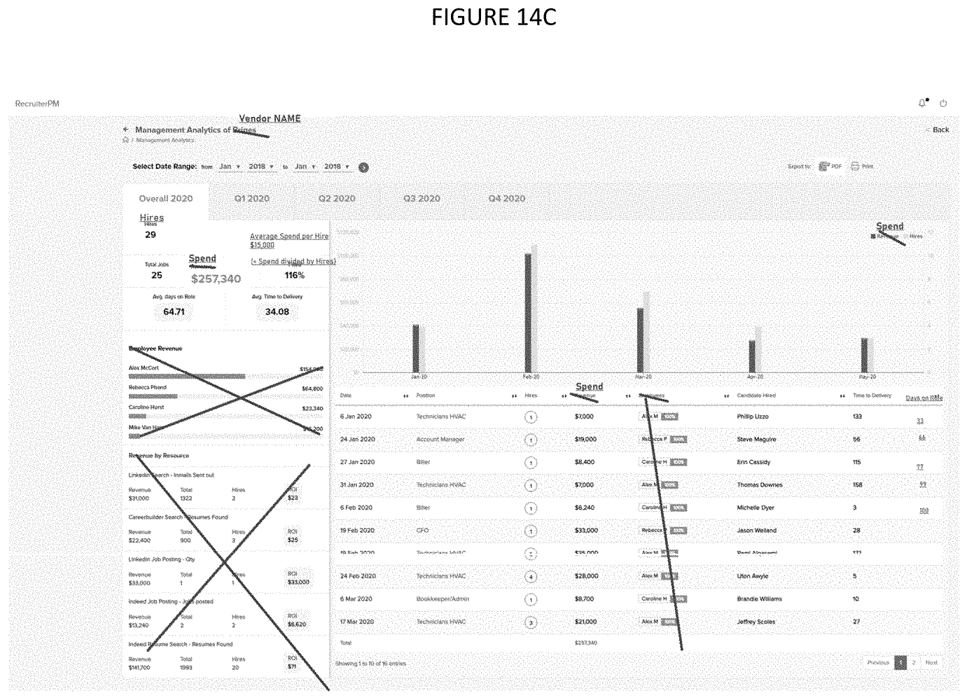

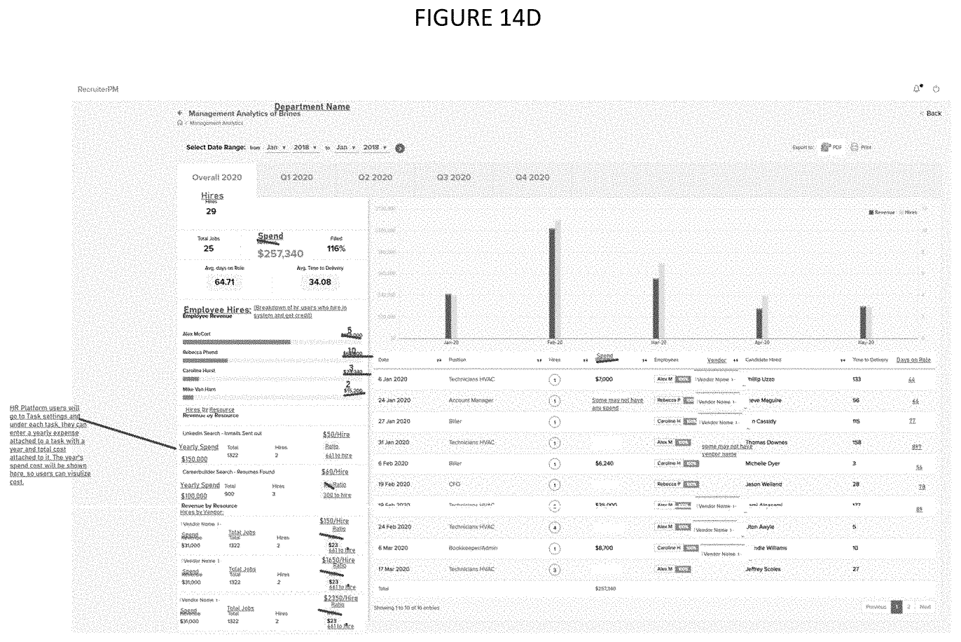

Management reports are further shown in FIGS. 14A-14D. FIG. 14A is a landing page of a department overview. FIG. 14B is a view of the vendor overview selection. FIGS. 14C-14D are views of management reports. Users can go to task settings and under each task they can enter a yearly expense attached to a task with a year and total cost attached to it. The year's spend cost can be shown so that users can visualize cost.

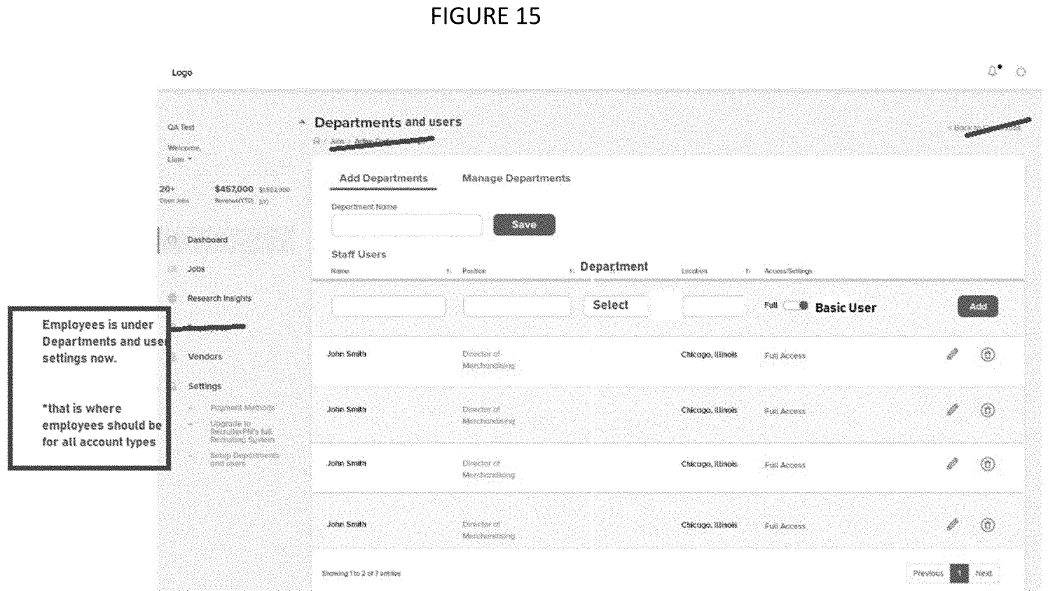

Departments and users can be shown as in FIG. 15.

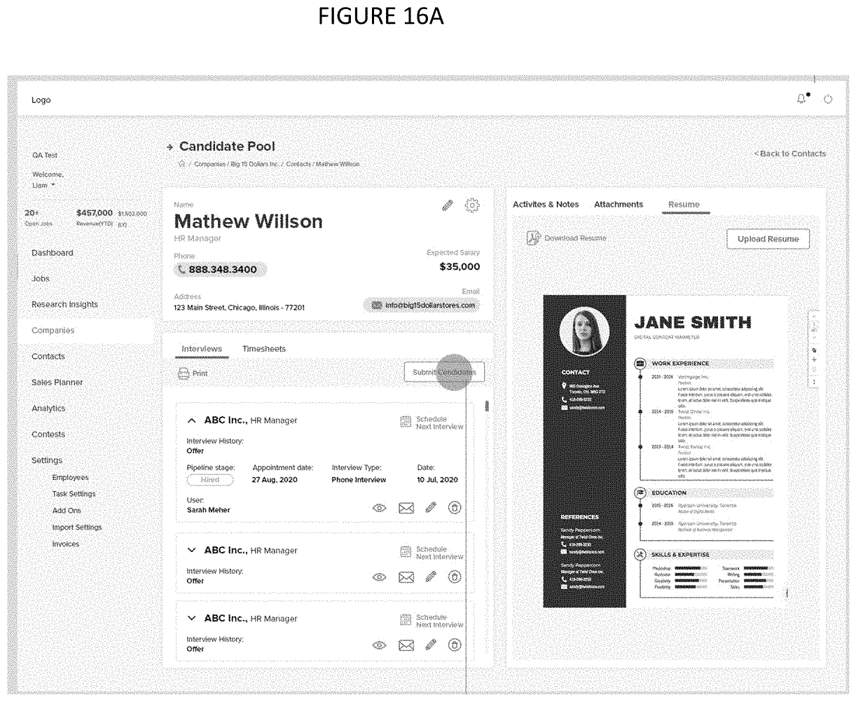

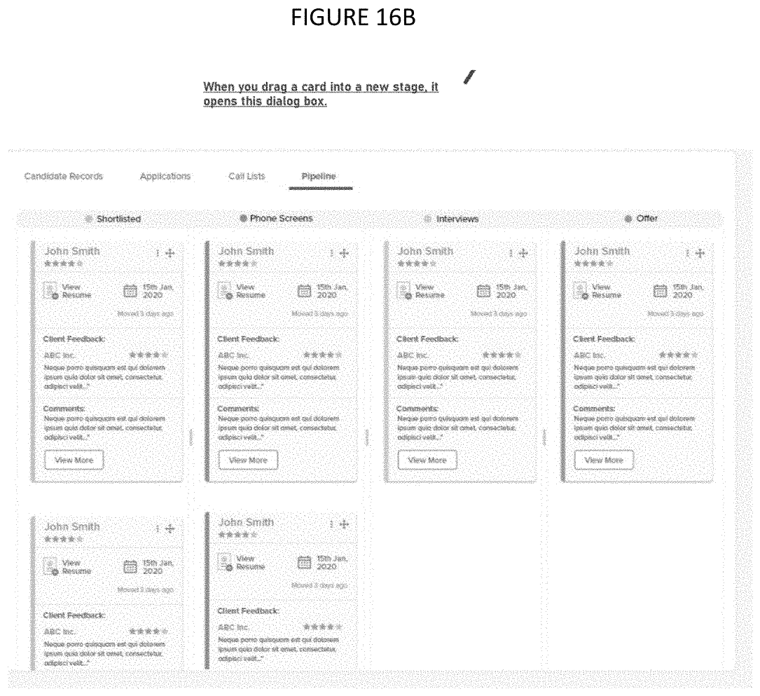

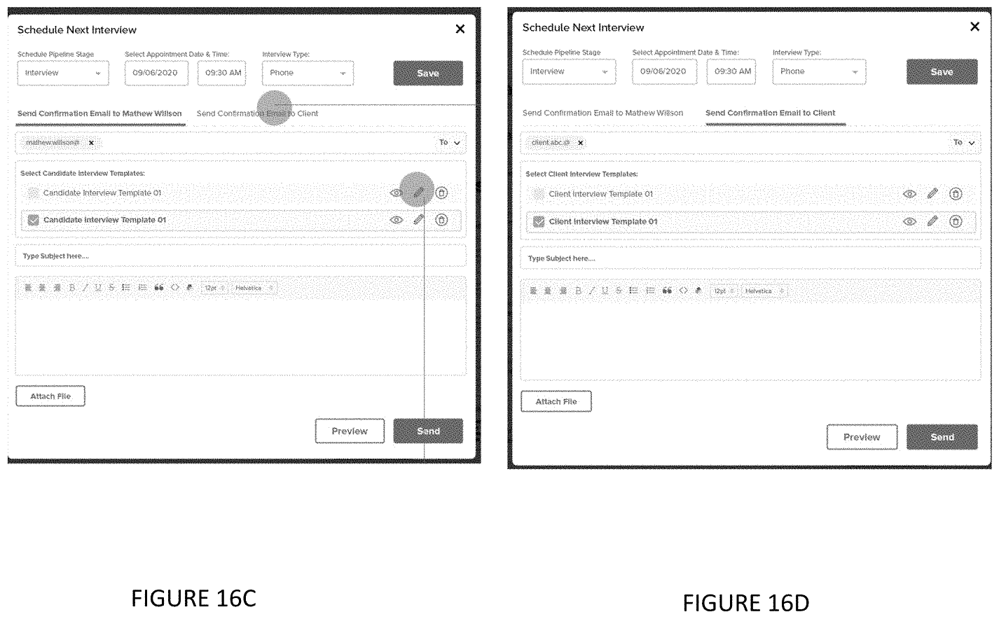

FIGS. 16A-16D show views of setting up interviews. FIG. 16A shows that only administration can delete, and only administration and user who made an interview can edit. FIG. 16B shows views of interview pipelines. FIGS. 16C and 16D show a candidate/client interview template, and administration can create interview types in settings on the same settings page/area as pipeline settings.

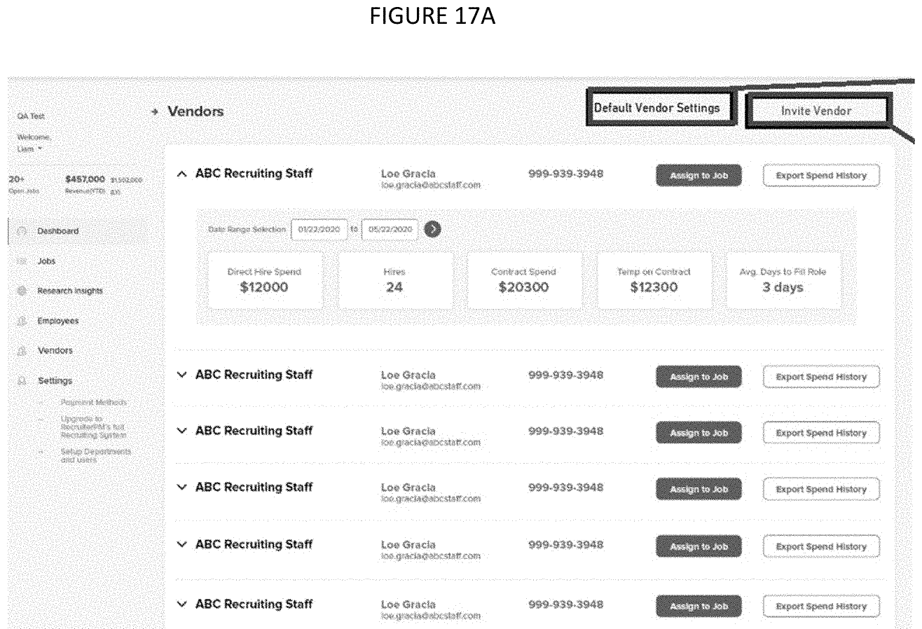

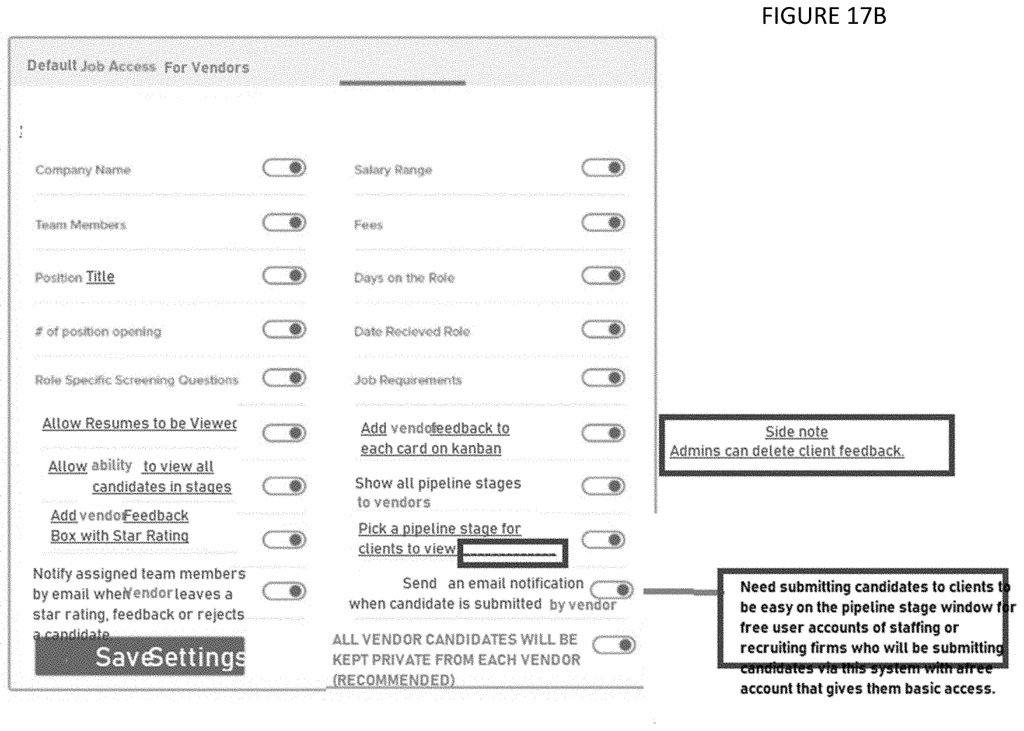

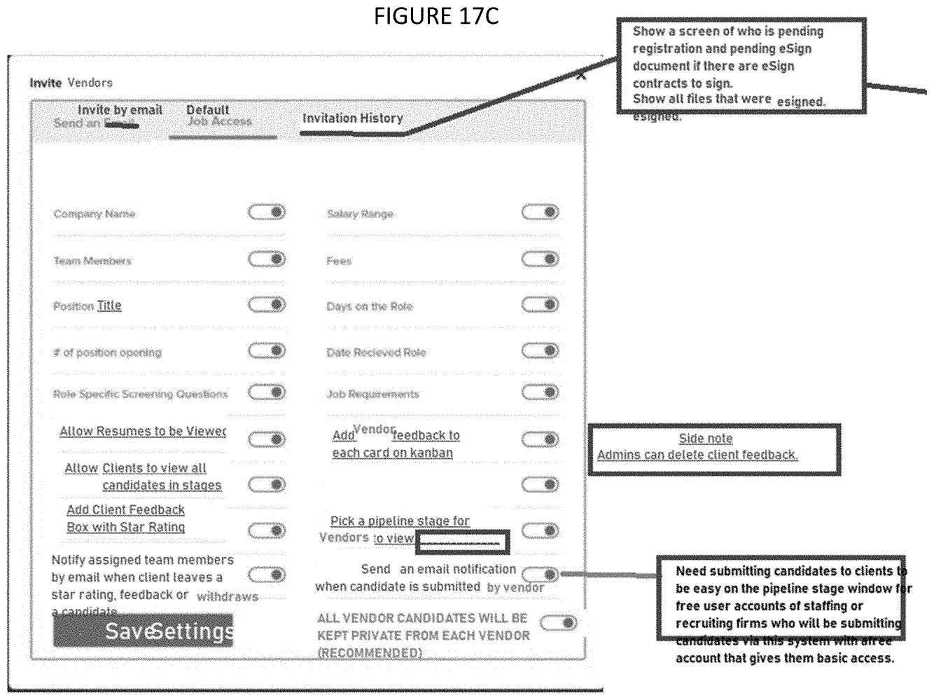

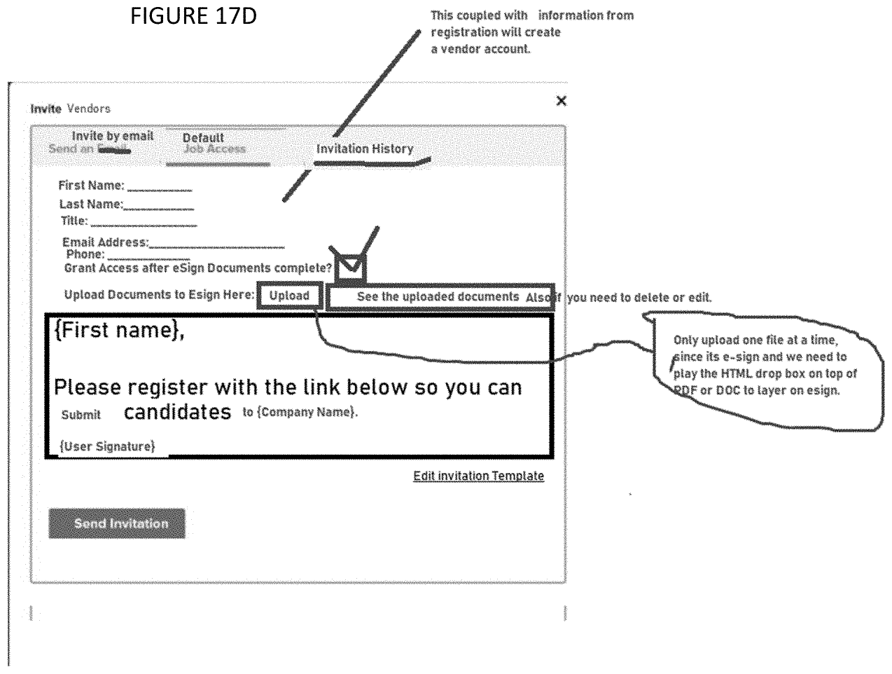

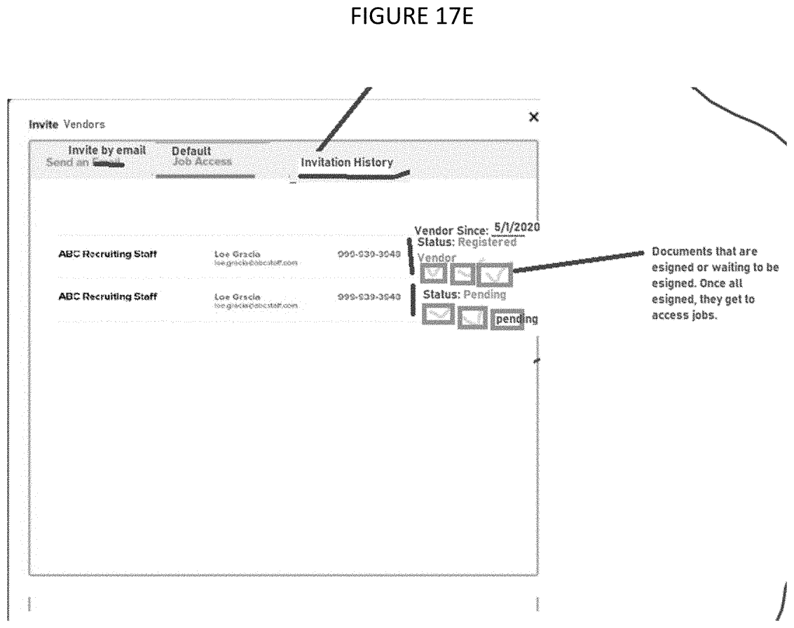

A vendor module 90 is shown in FIG. 17A. Clicking on “Default Vendor Settings” arrives at the view in FIG. 17B where various settings can be toggled on or off. Administration can delete client feedback. Submitting candidates to clients can be easy on the pipeline stage window for free user accounts of staffing or recruiting firms who will be submitting candidates via the system 10 with a free account that gives them basic access. Clicking on “Invite Vendor” in FIG. 17A arrives at the view in FIG. 17C, where various settings can be toggled on or off. Clicking on “Invitation History” arrives at a view in FIG. 17D showing a screen of status of who is pending registration and pending esign document if there are esign contracts to sign, and all files that were esigned can be shown. This coupled with information from registration will create a vendor account. FIG. 17E shows a view of invitation history where documents that are esigned or waiting to be esigned are shown. Once all are esigned, the vendor can access jobs.

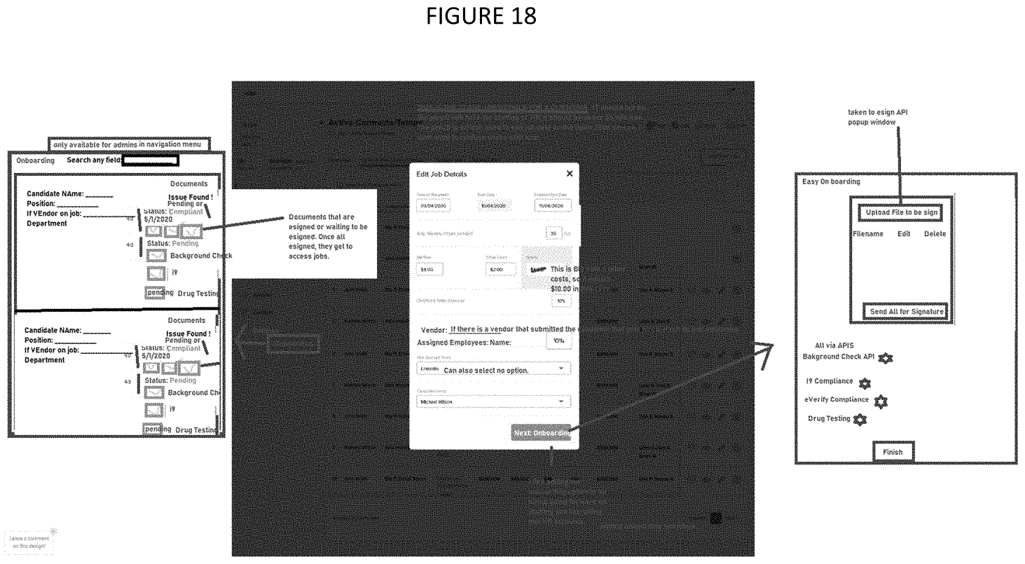

The system 10 can include an onboarding module 100 shown in FIG. 18. Files can be uploaded to esign. It can be shown what documents are esigned or are waiting to be esigned.

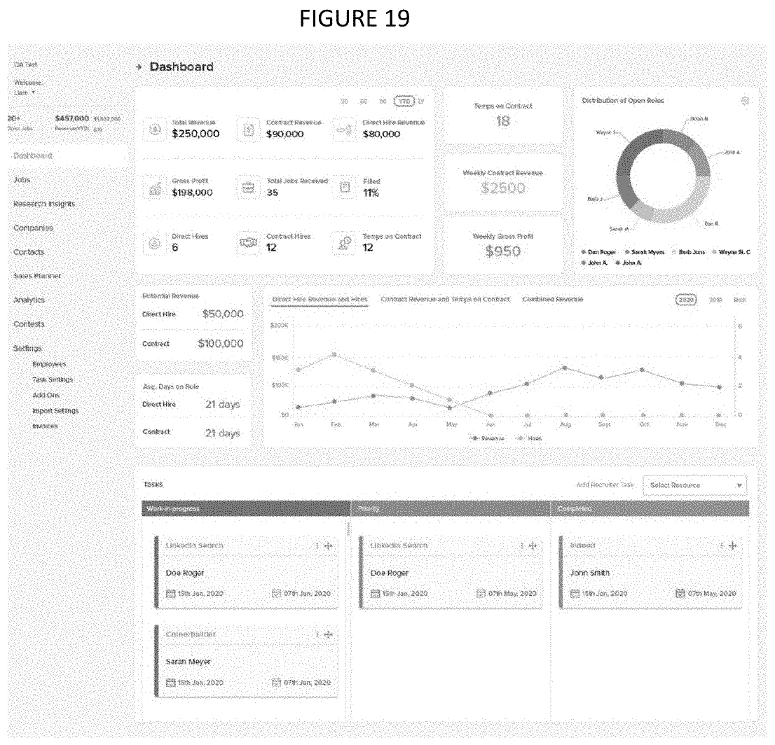

FIG. 19 shows a staffing firm dashboard 24. There is the ability to break down all profit margins, revenue and distribution of workload within one simple dashboard interface for staffing agencies hiring contract and temporary employees. This allows one to break down both contract/temporary staffing and direct hire staffing revenue. In addition, it brings about project management via a drag and drop task platform on the bottom that builds analytics in the backend based on tasks, tasks completed, days to complete and which tasks brought out revenue and how much revenue and hires were made behind different resources used within an office.

The system 10 includes a jobs section. For years, recruiters had to go to multiple job boards and websites to source and find candidates and that included going to sites such as CareerBuilder, Monster, Indeed and numerous others. Within the job section, users are able to search across all job boards through a centralized search interface that utilizes the artificial intelligence and natural language processing of third party APIs to power the search across many websites. This enables users to stay within the system 10 platform while interacting with a smarter search interface and have the ability to see results of all of their paid subscription resume databases in one place with a rating system embedded. Users also have the ability to use job information already supplied to the system 10 for job distribution or a career page job posting and then utilize AI APIs to assess and find results with a quick one-click button for quick matches to the job description provided.

Utilizing diversity job-application focused processes based on OFCPP and EEO, the internal search enables users to focus on enhancing diversity inclusion hiring methodologies via filters available in the candidate search interface.

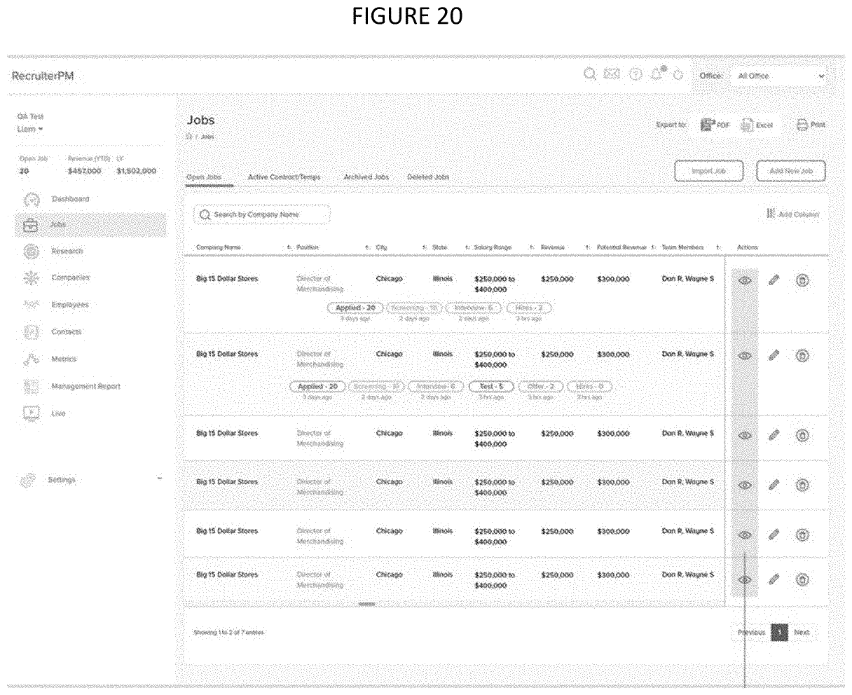

FIG. 20 shows an open jobs section. In this area, one can see an overview of all open jobs and what is going on in each open job with a mini overview of the pipeline of each open position and how many candidates are in each step of the process. This can be used by both staffing and recruiting firms. In the overview page users can see every action performed including; job post performance across each external job board, every search string used to find candidates across all resume databases, every research task, every call, interview, phone screen and pipeline event, and this is summarized in a screen that combines data, workflow, process and success rates in a easy to view screen.

All searches allow users to see a gauge on how closely the candidates fit a search based on filters, experience levels, skills and years of experience within a skillset. In the search window, users can compare candidates founds, add candidates to campaign lists, and then market to them via an SMS and email campaign.

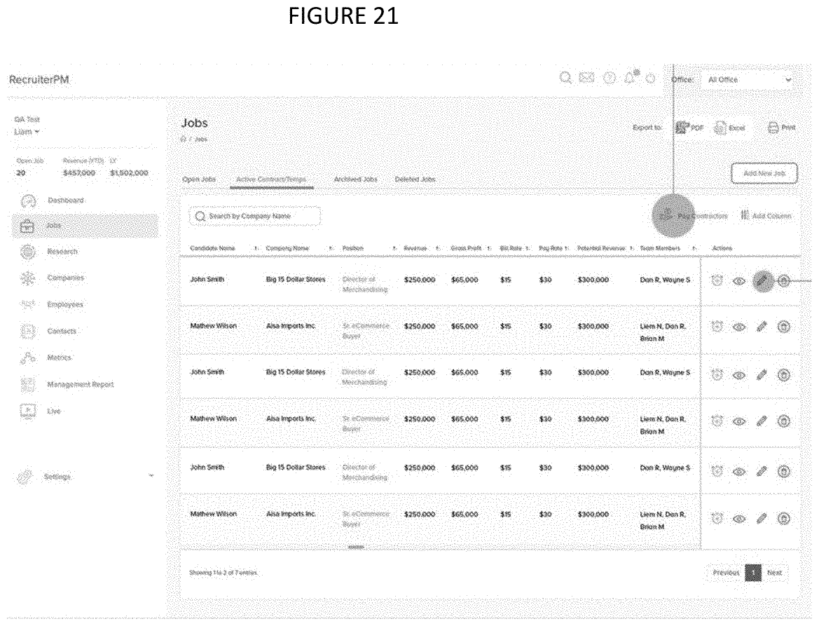

FIG. 21 shows an active contracts/temps section. This allows one to see the current contract hires and temporary employees and how much money is being earned with each contract hire, the bill rate, and the potential revenue still left over to bill out on each line item. This can be used by staffing firms.

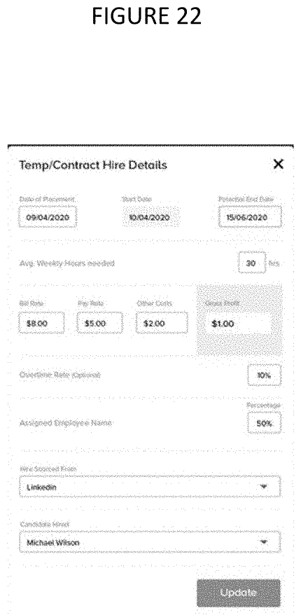

FIG. 22 shows temp/contract hire details. There is the ability to view and add in details about a hire and then utilize the data for analysis around which resources were used to make the hire and from there build the dashboard reports around resources and tasks and the revenue that comes about from those associated activities. The hire can be credited to employers to understand employee performance associated with tasks and revenue. The resource used to make the hire can be added to equate that back to the tasks associated.

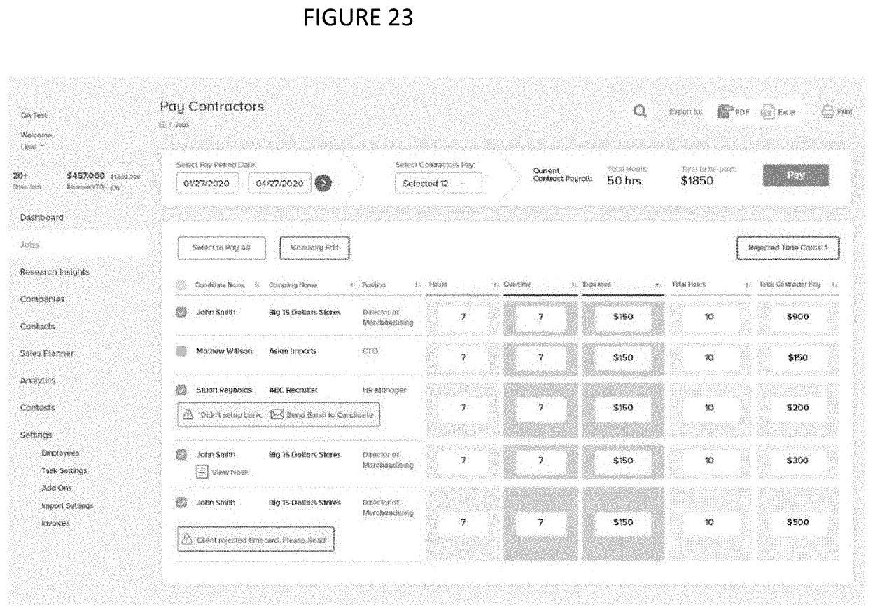

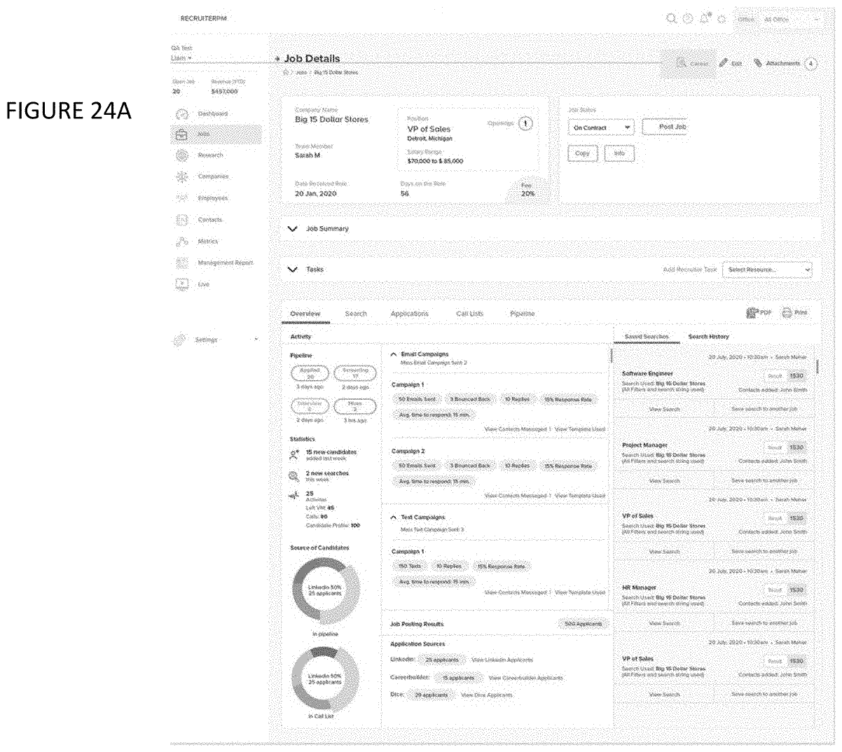

FIG. 23 shows a view of paying freelancers, contractors, and temps via the system 10 with the ability to keep track of hours and expenses.

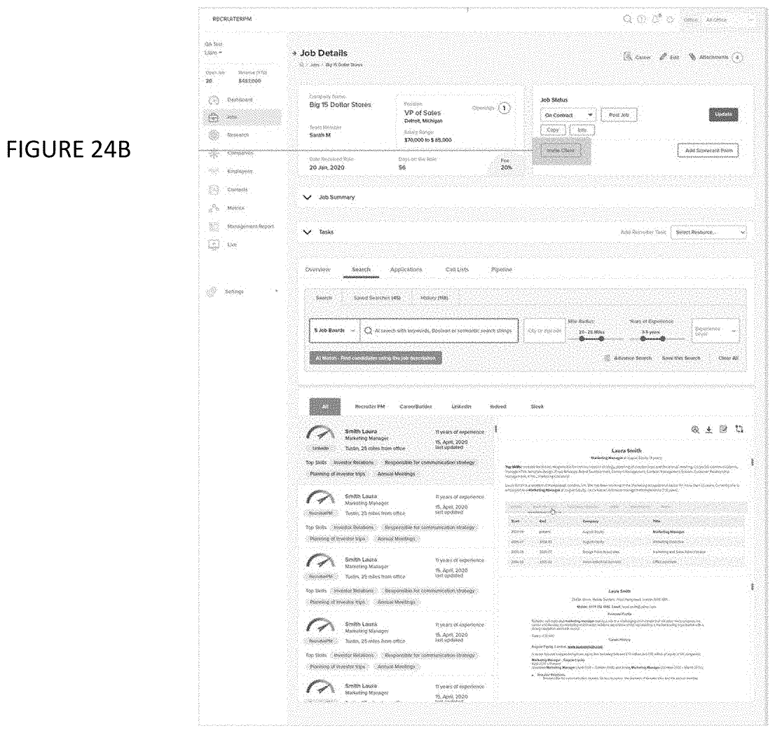

FIG. 24A shows a job overview details page that allows all users to see all tasks, pipelines, call lists, applications, and all project related documents in one easy to use screen without leaving the screen for any functions to operate a recruiting assignment. This also allows for users to invite clients and vendors to jobs to submit candidates and feedback for end user and vendor coordination and collaboration within the same tool and page. FIG. 24B shows an embedded search page experience on the job details page. This allows users to remain on the page and search within a job overview page across many websites using an AI. In one easy to view experience everything is within one click to access, so leaving the page is not necessary to source candidates, communicate, and market to them and then manage them in the pipeline via the job overview page tabs. Usually search pages are separate websites or pages from the job overview page and are not using job information unless it is fed data. The system 10's job overview page uses the information it has from the job description and then using that data it finds the find best matches with the click of a button all within the same screen and it uses a gauge to then show the best matches.

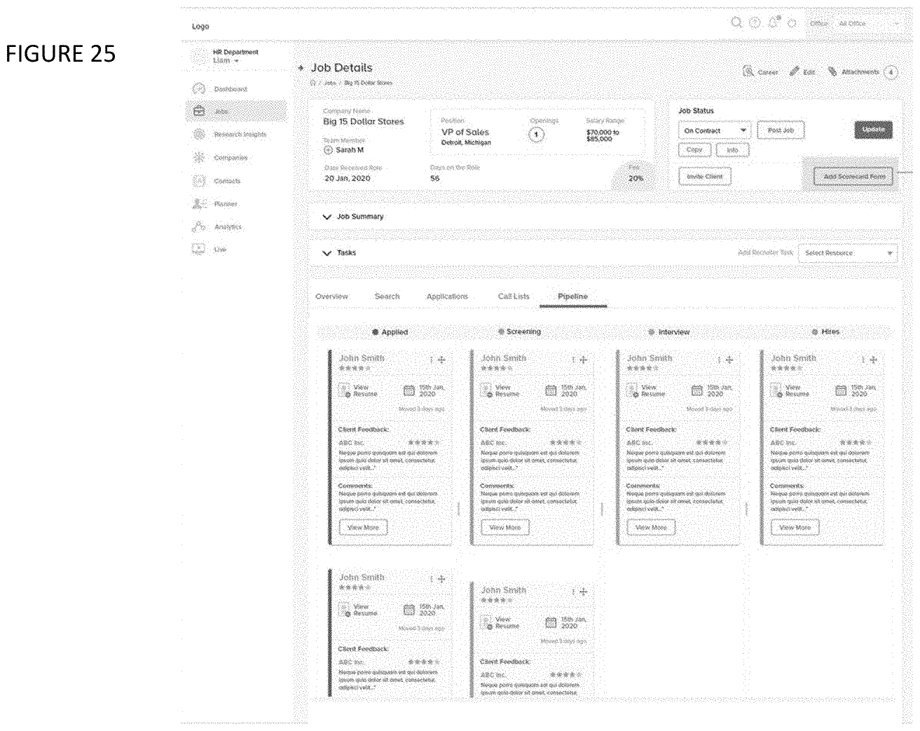

FIG. 25 shows a view wherein client feedback and a feedback score are shown in addition to the entire pipeline of all interviews.

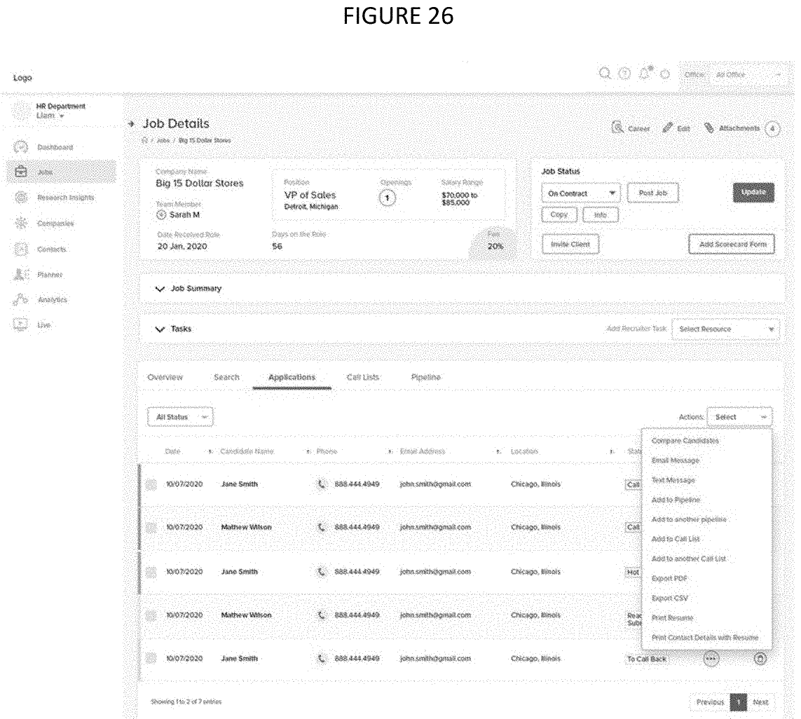

FIG. 26 shows the call lists within the same page, allowing users never having to leave the page to handle all the steps of the recruiting process from calling applications, to cold calling new potential talented individuals as well as managing the pipeline.

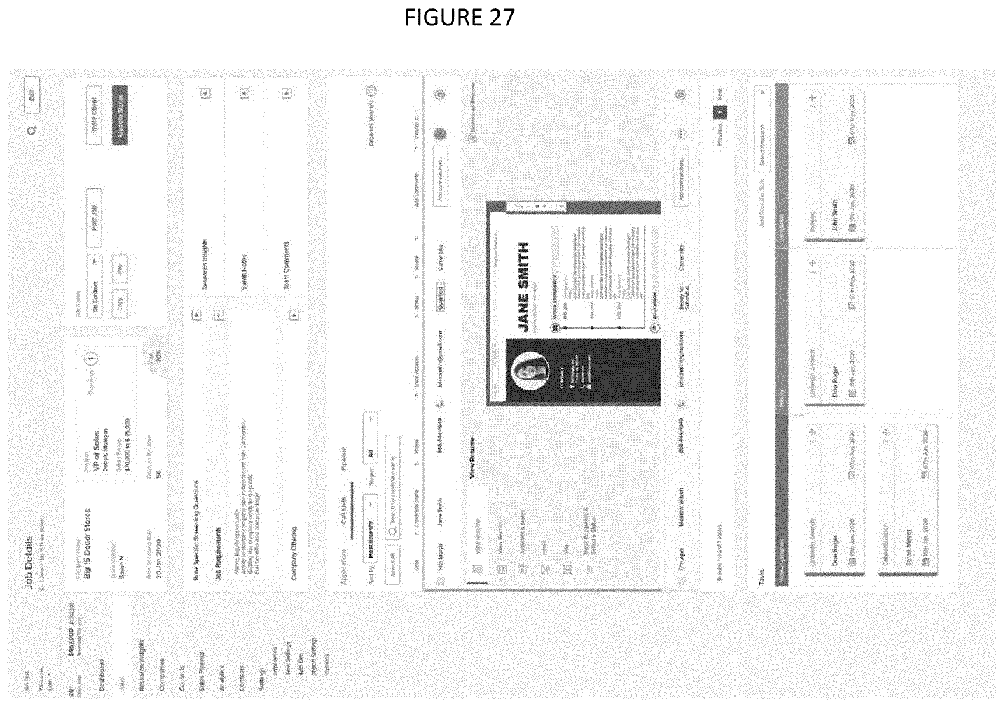

FIG. 27 shows that resumes can be viewed within the same screen and email and text campaigns can be created within the screen as well for candidate marketing purposes.

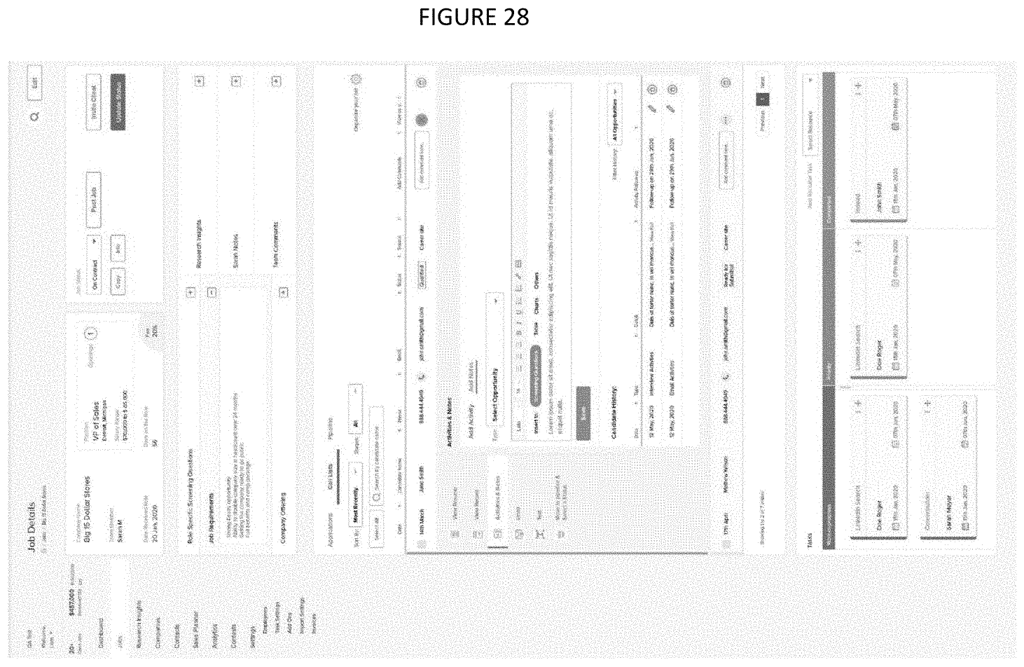

FIG. 28 shows that there is the ability to quickly add in a phone screen or interview within the project job details screen, in order to further increase efficiency.

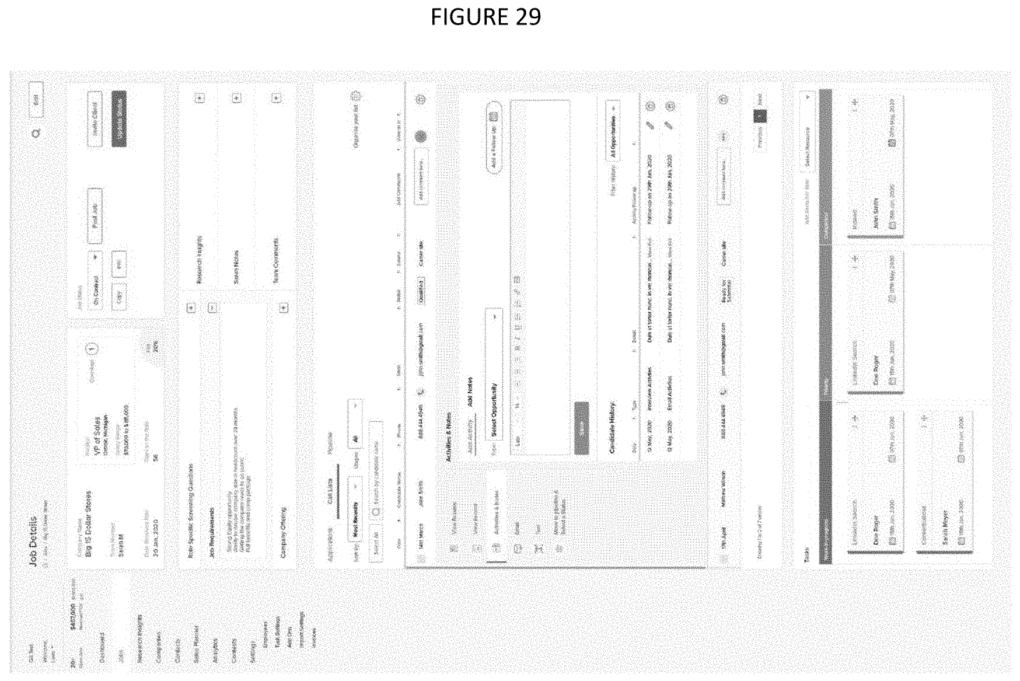

FIG. 29 shows that there is the ability to track all activities of every conversation with candidates from the same project screen and have it automatically filter into a CRM platform that allows for true contact management.

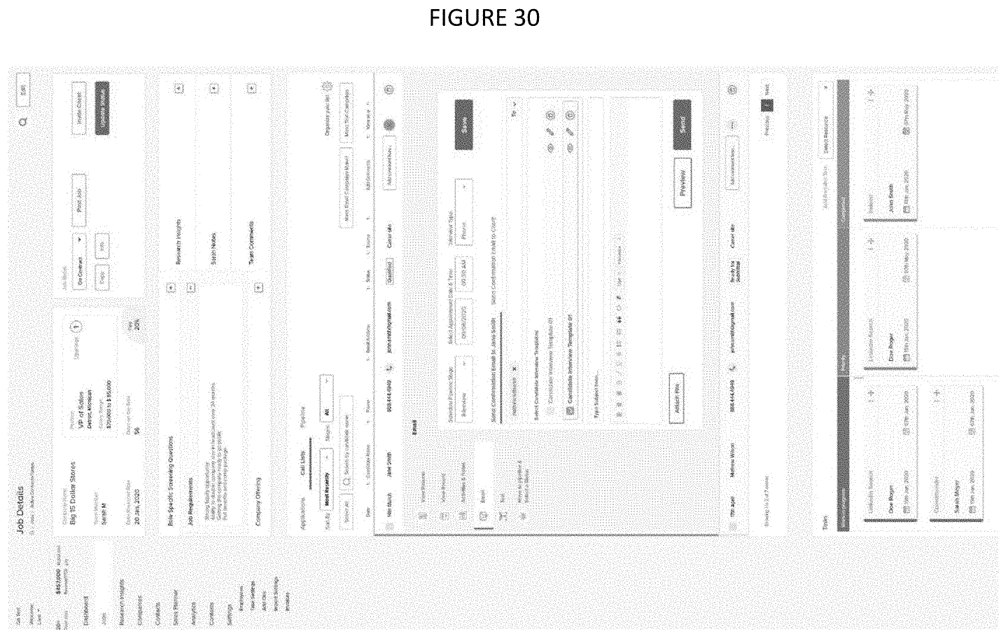

FIG. 30 shows that users can quickly move candidates within the interview process without leaving the job detail project screen. In this window, the user can quickly email all parties involved with the interview the details of the interview.

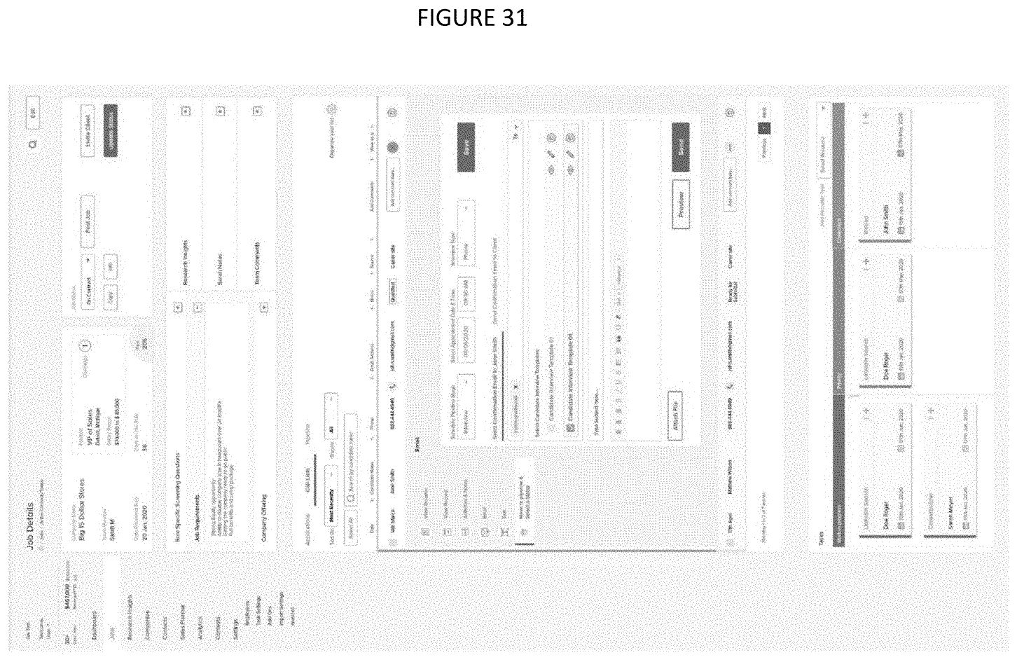

FIG. 31 shows a window that allows the candidates to be in the loop of all interview processes via email notifications.

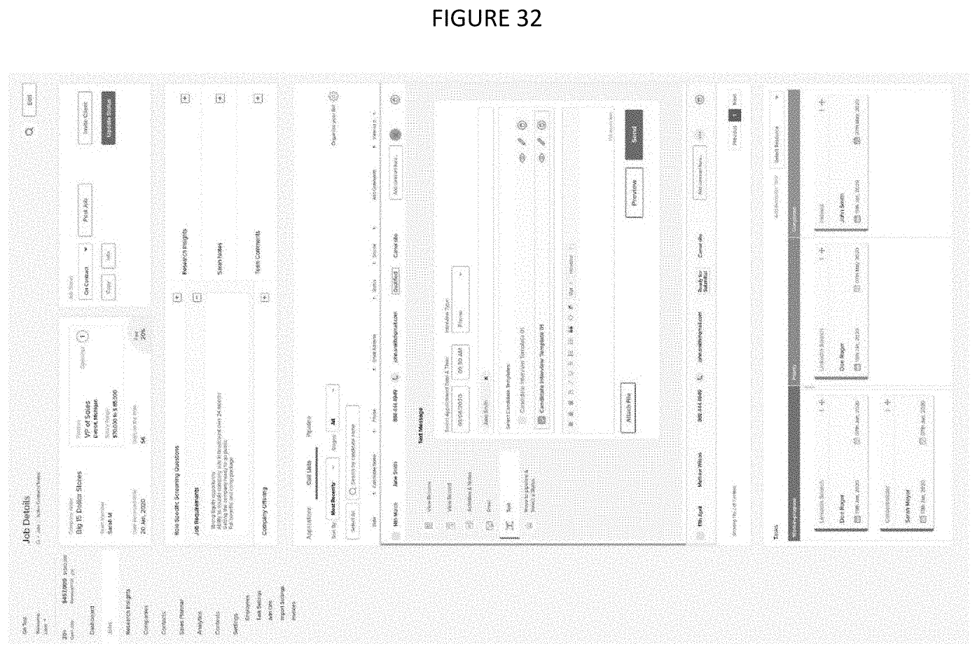

FIG. 32 shows the ability to create text message marketing campaigns within the project to enable marketing campaigns from the same screen.

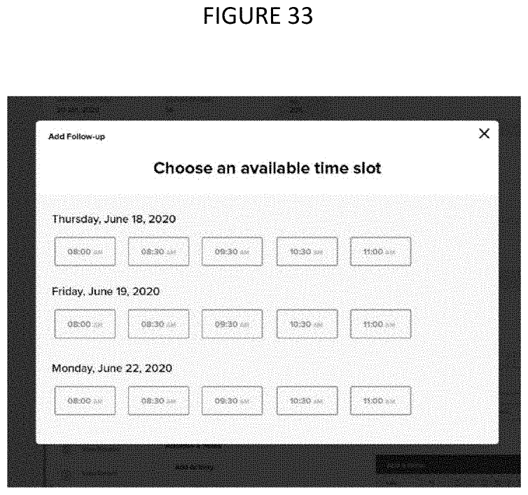

FIG. 33 shows a window with the ability to create follow ups based on availability on all calendar types for end users via API integrations with all major calendar companies (Google, Outlook, iCloud). From this integration, interviews can be scheduled, and calls can be scheduled automatically via a calendar scheduler tool accessible for all user types to both schedule interviews and internal meetings.

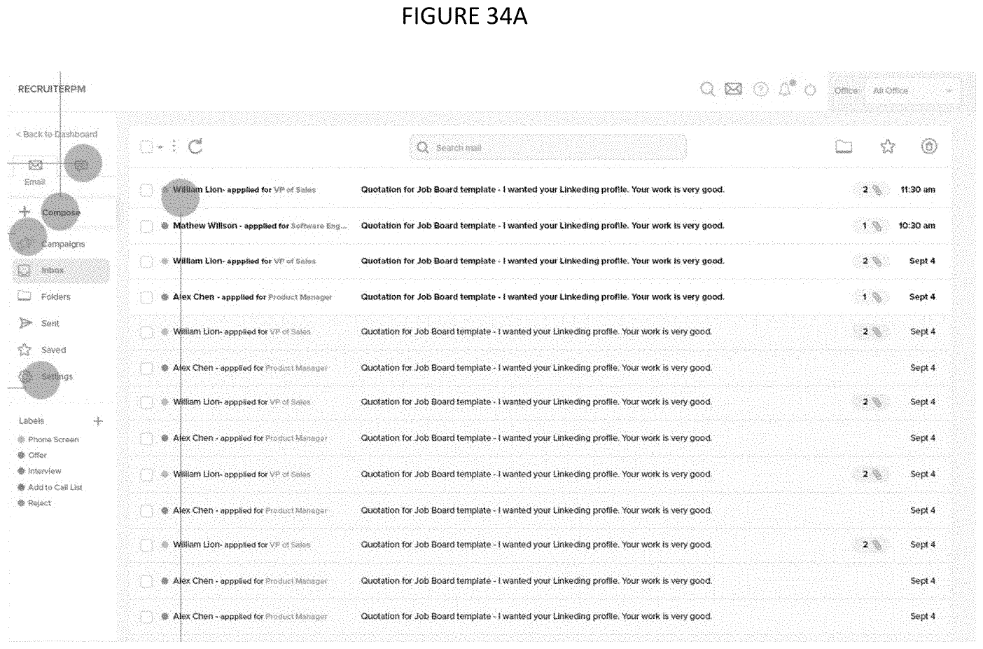

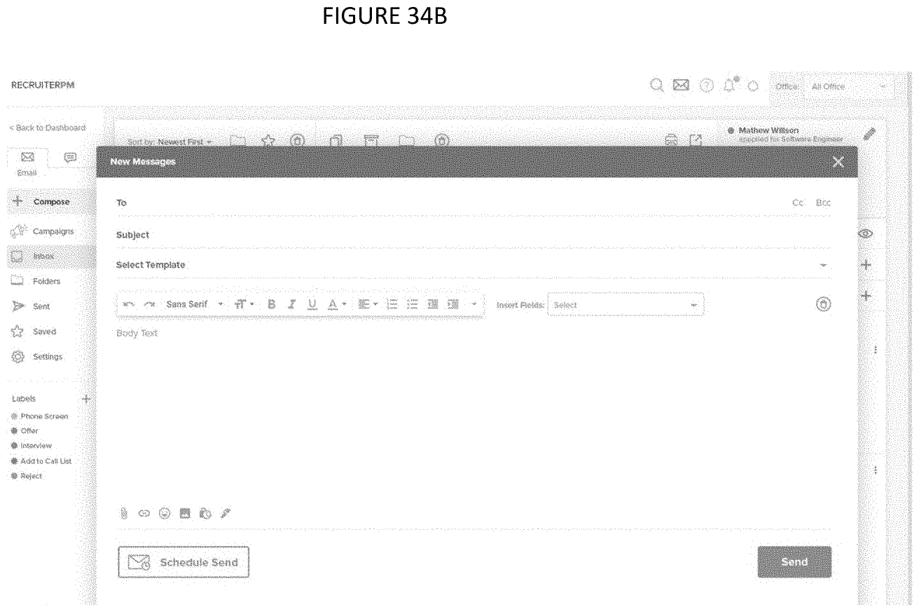

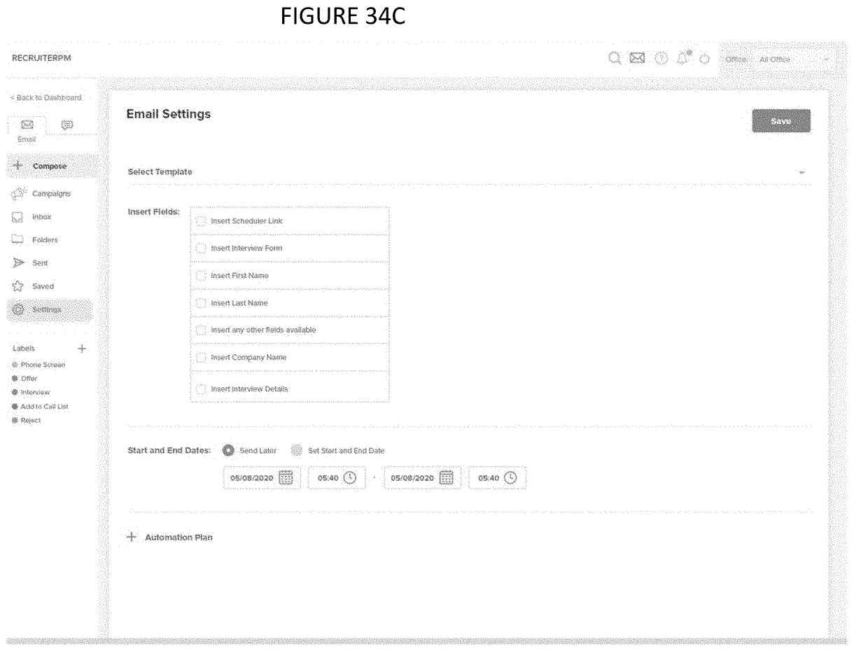

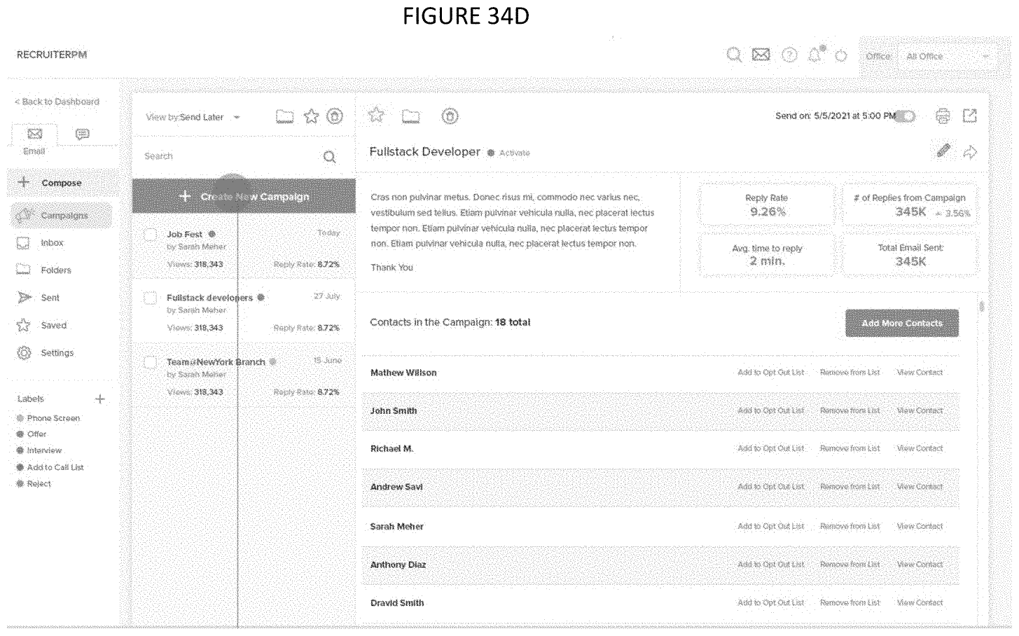

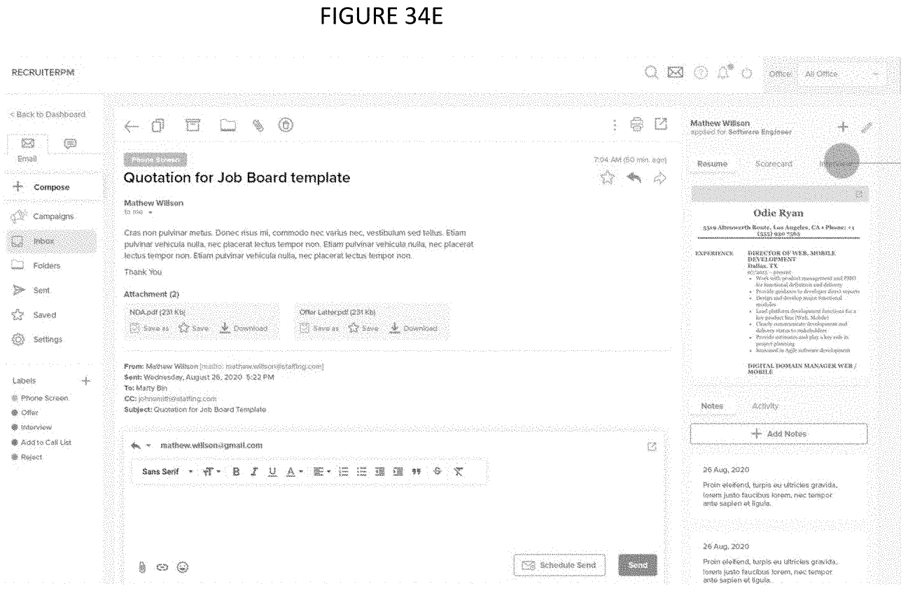

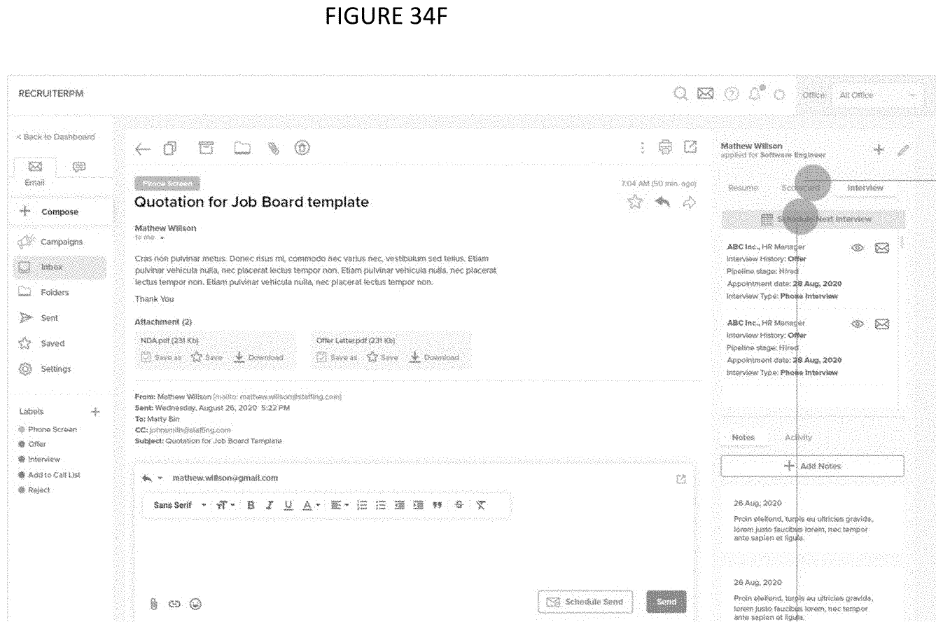

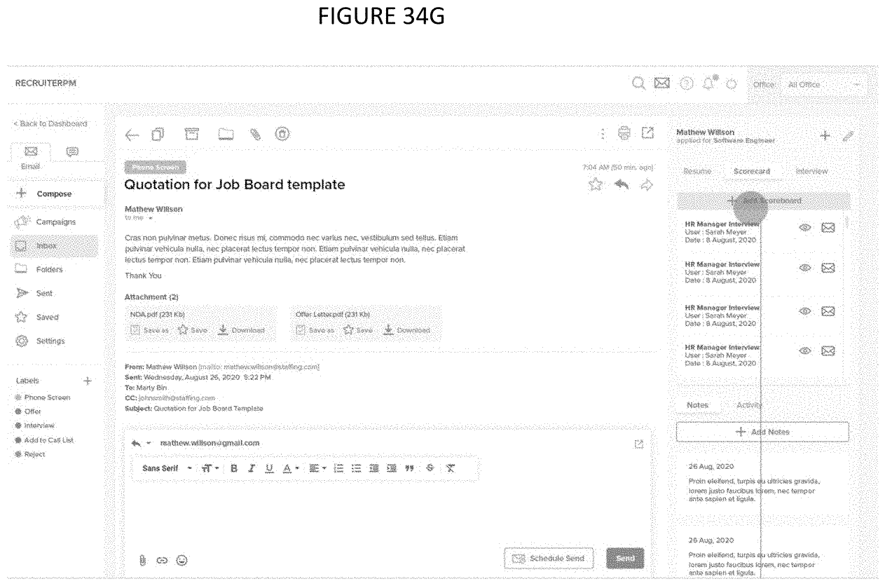

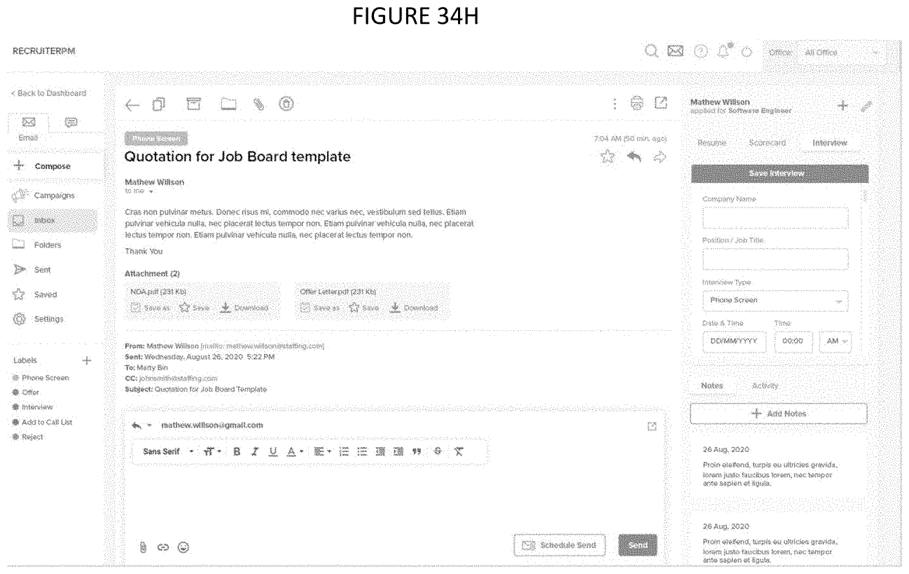

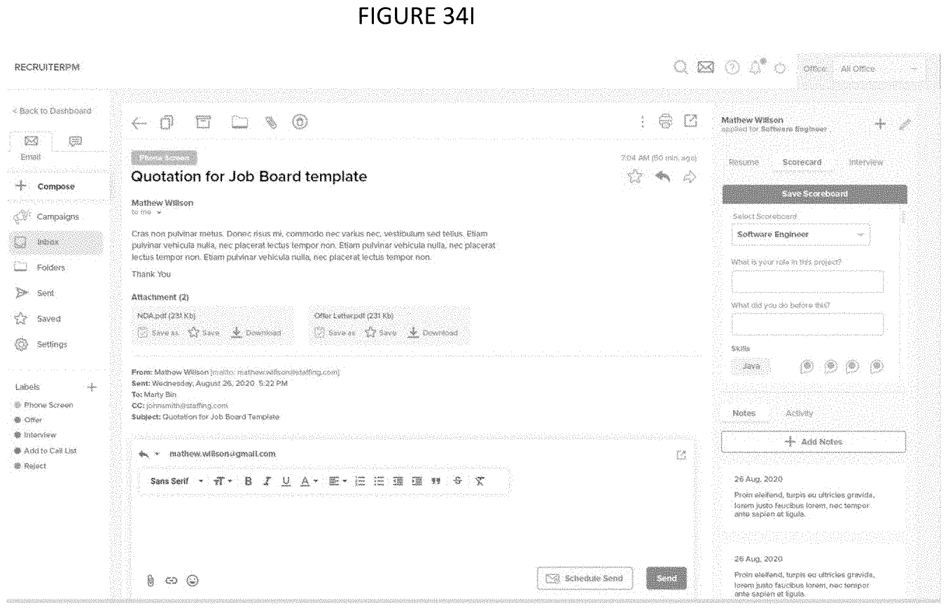

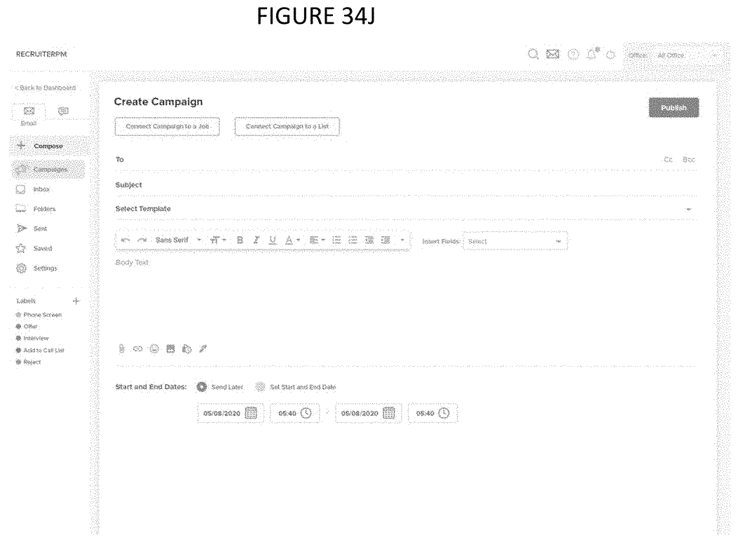

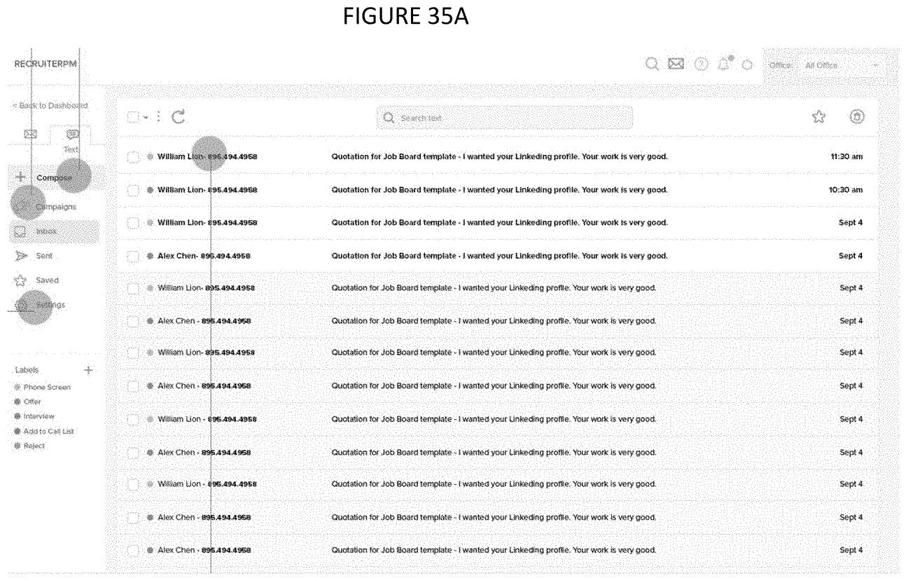

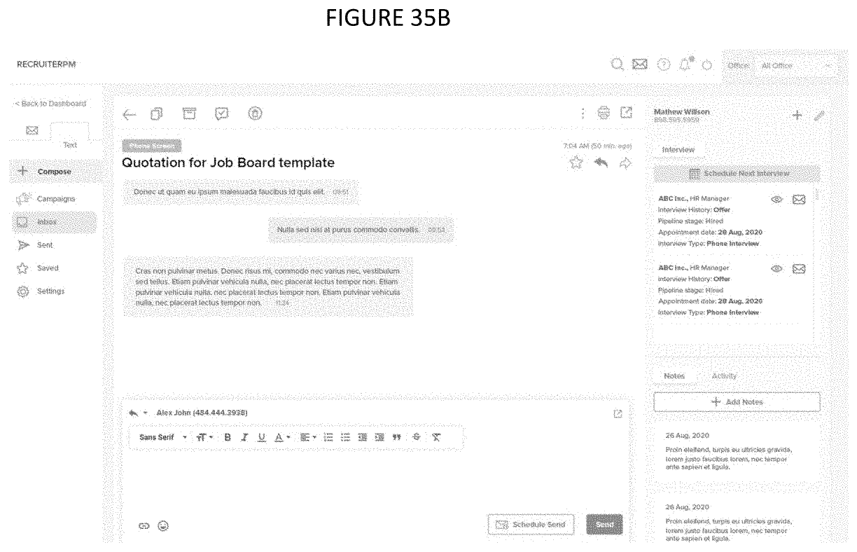

In a communication module 110, users are able to access any email account and text messaging using APIs built in, and while navigating and browsing email and text messages, they are able to view all history between contact and user of the system 10 across contact details, activities, notes, interviews, and all contact management action items seamlessly and accessible from an internal email application window. All attachments in an email can be automatically saved and parsed into the system 10 within the same email window, so it allows ease and flow between the system 10 and email. FIGS. 34A-34J shows views of email, and FIGS. 35A-35B show views of text messages.

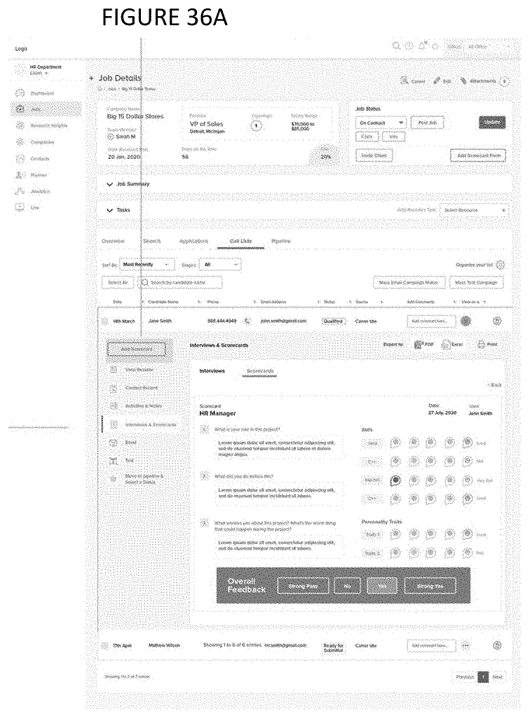

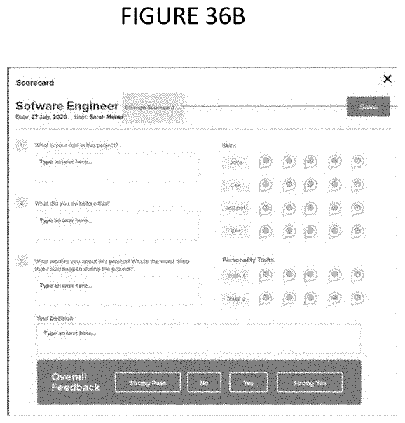

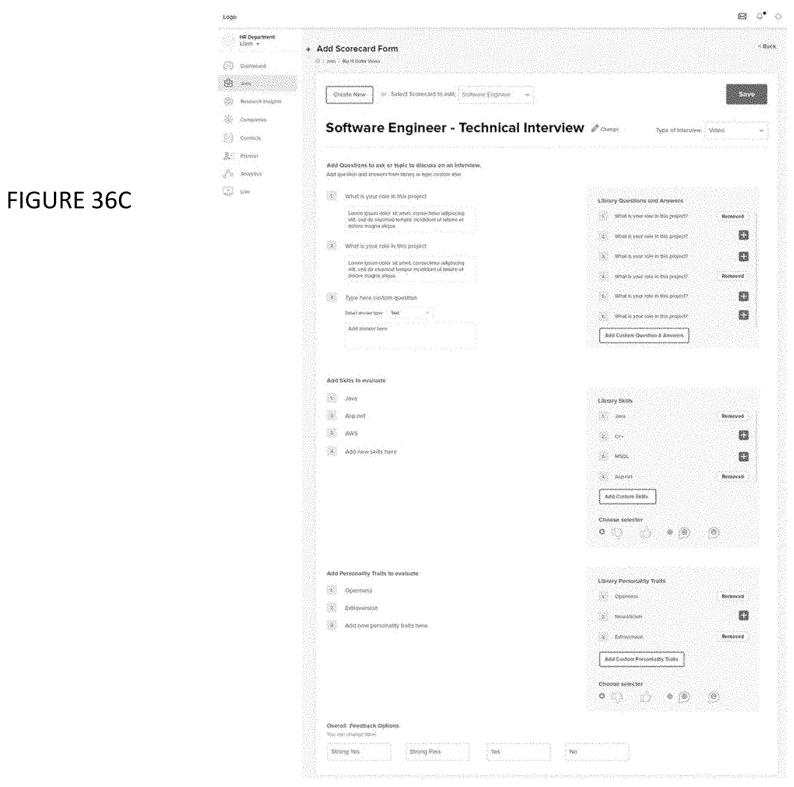

Custom scorecards can be created by all users, shown in FIGS. 36A-36C, since every interview process is different with numerous questions ands kills being assessed. The scorecards allow users to pre-make questions and skills to rate and while on the interview, users are able to quickly fill in these scorecards and share them across all users types and email them as documents to hiring managers.

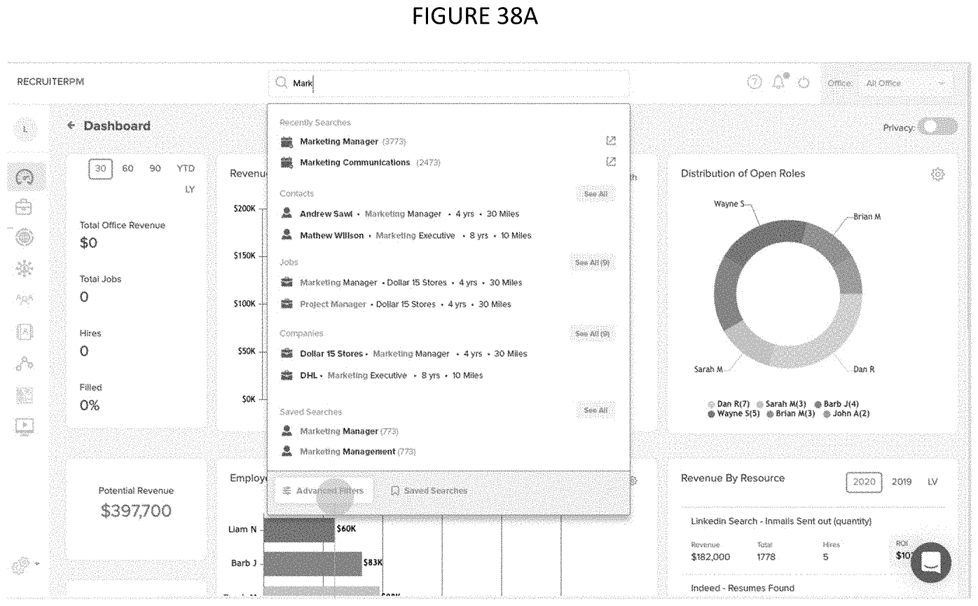

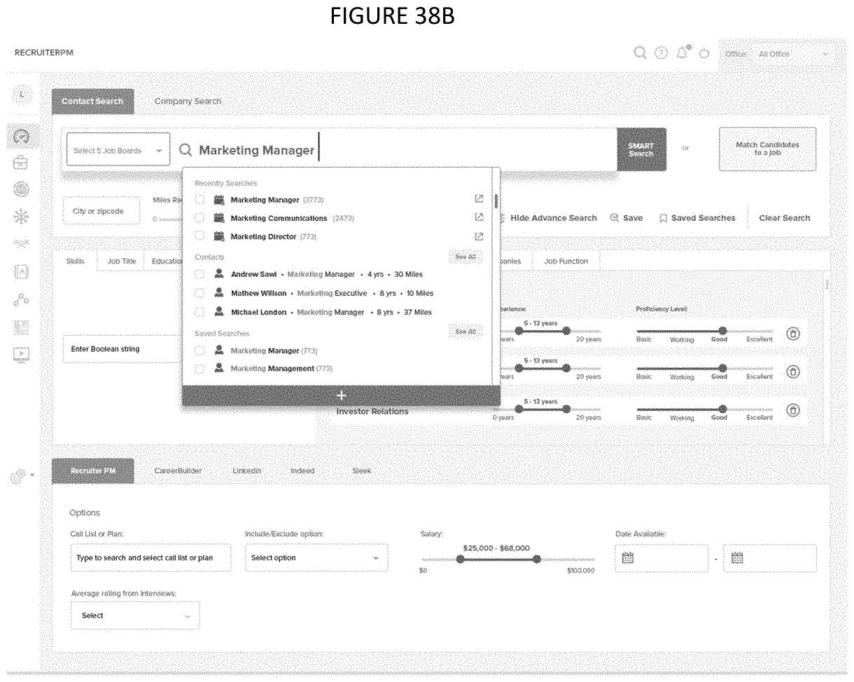

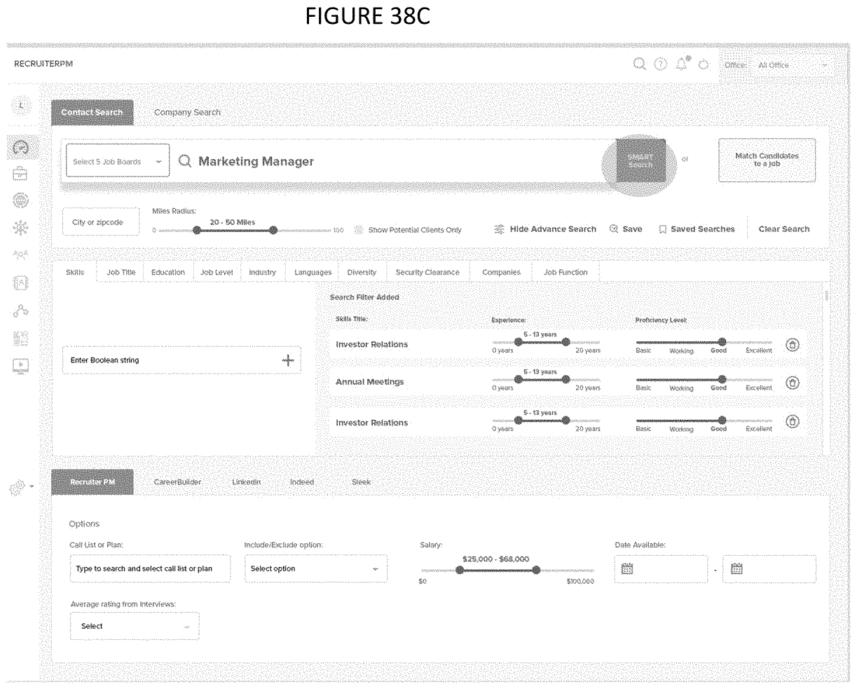

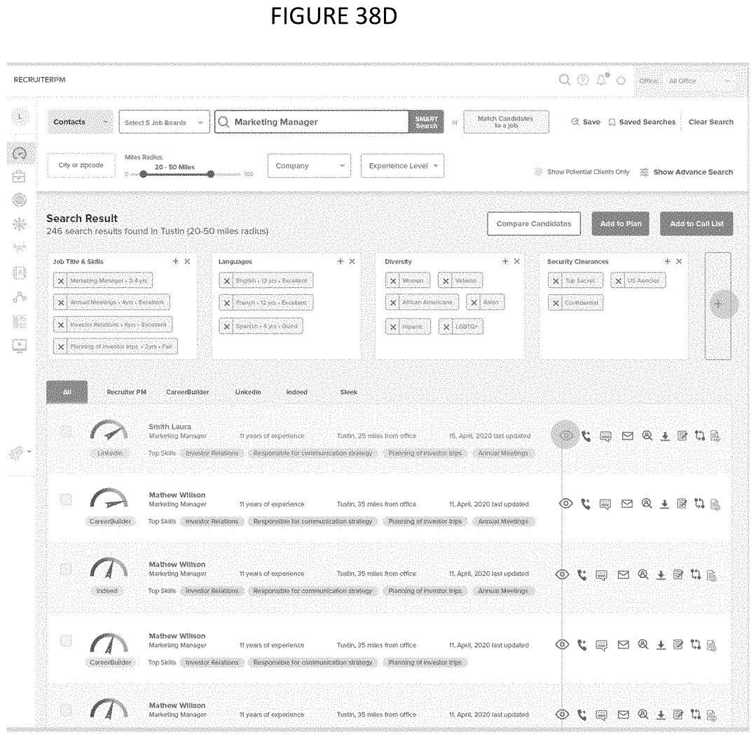

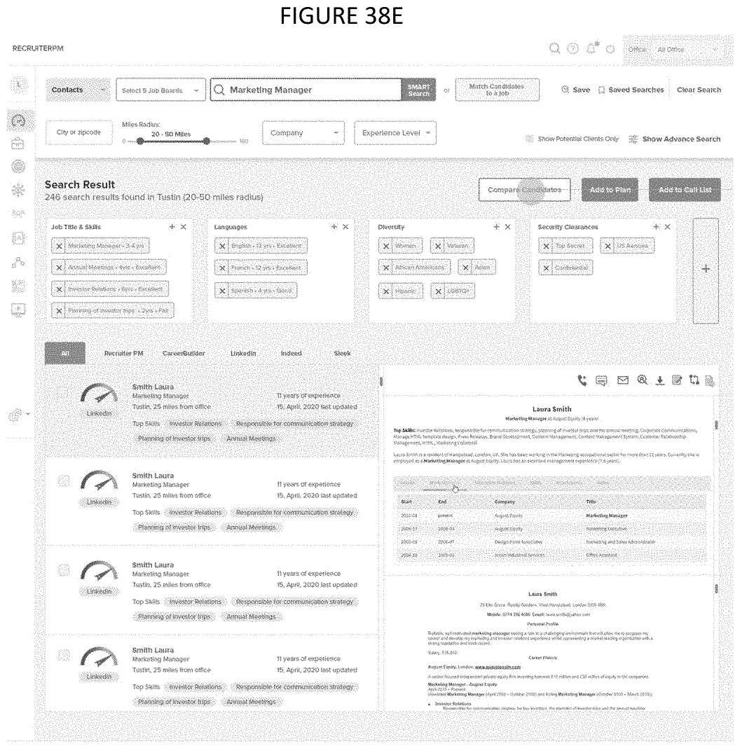

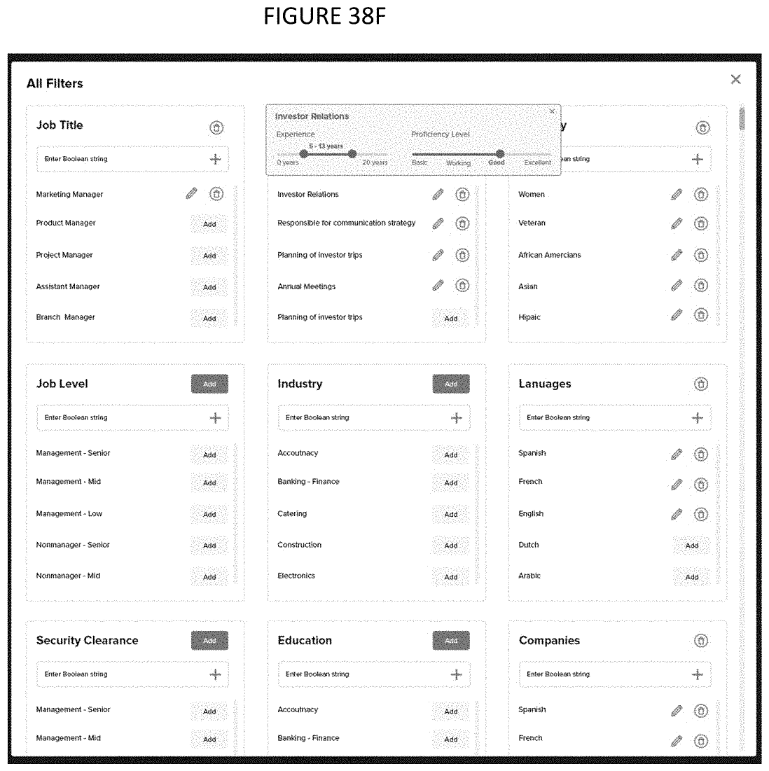

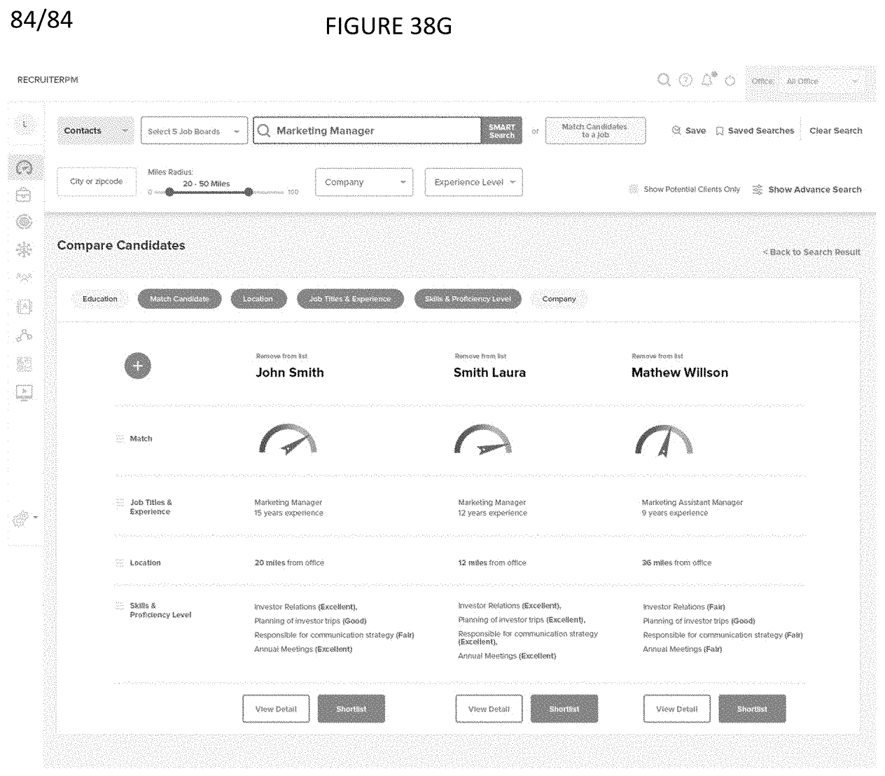

A global search is shown in FIG. 38A. FIG. 38B is a view of a contact search. FIG. 38C is a view of options for a smart search. FIG. 38D is a view of search results. FIG. 38E is a view of search results.

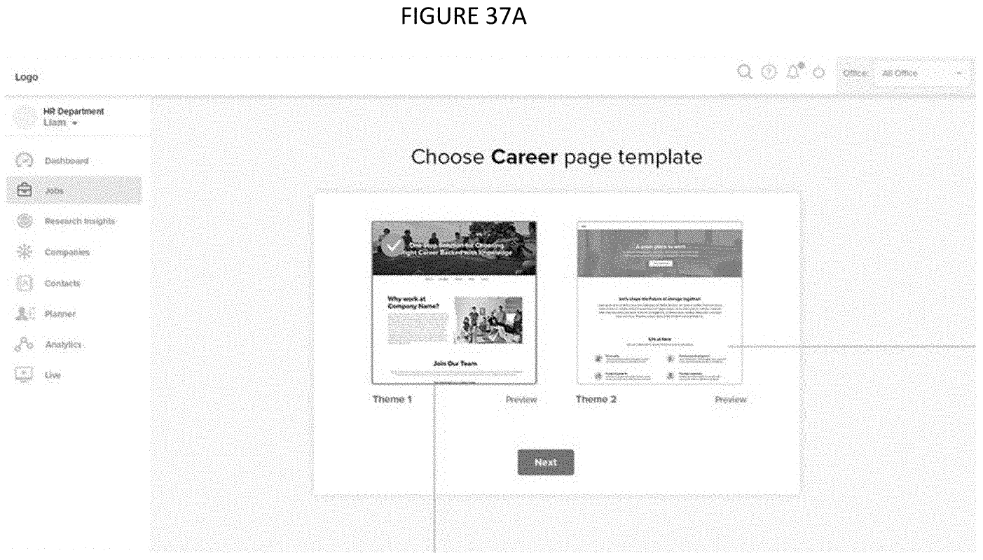

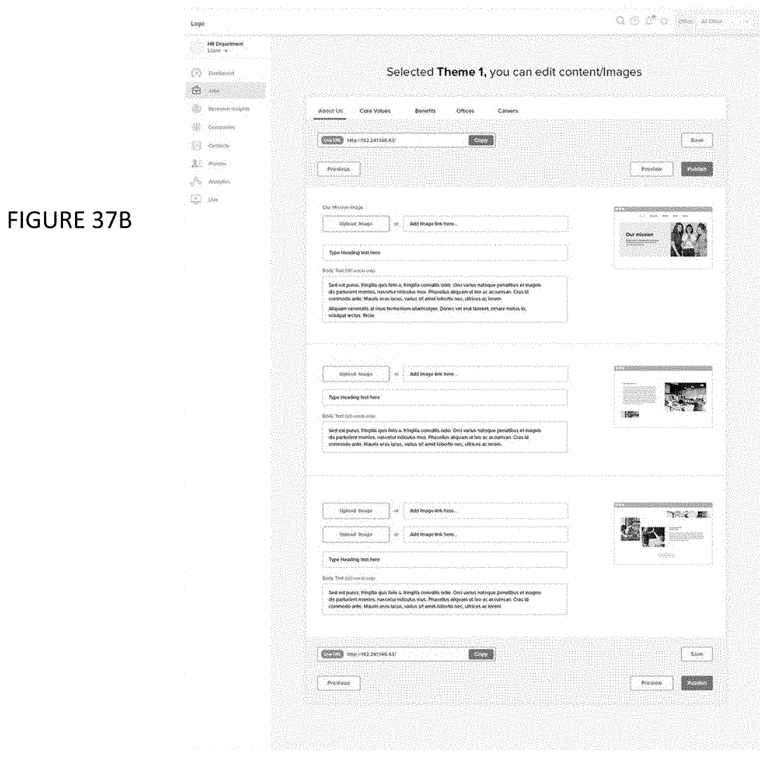

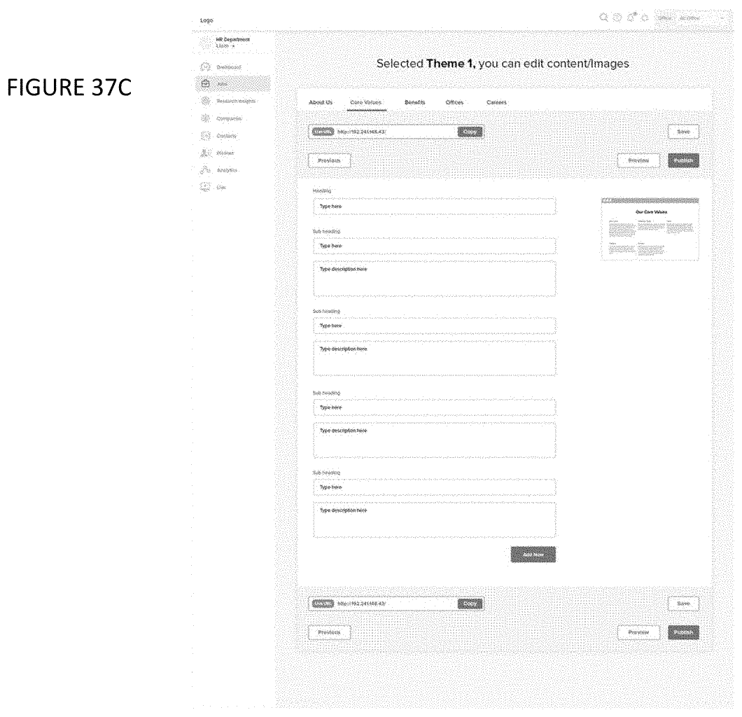

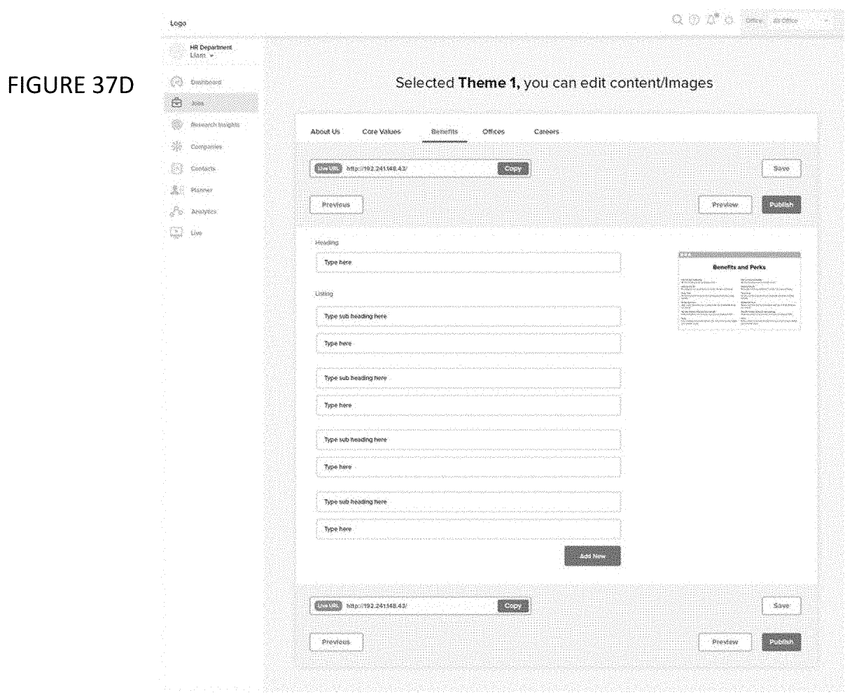

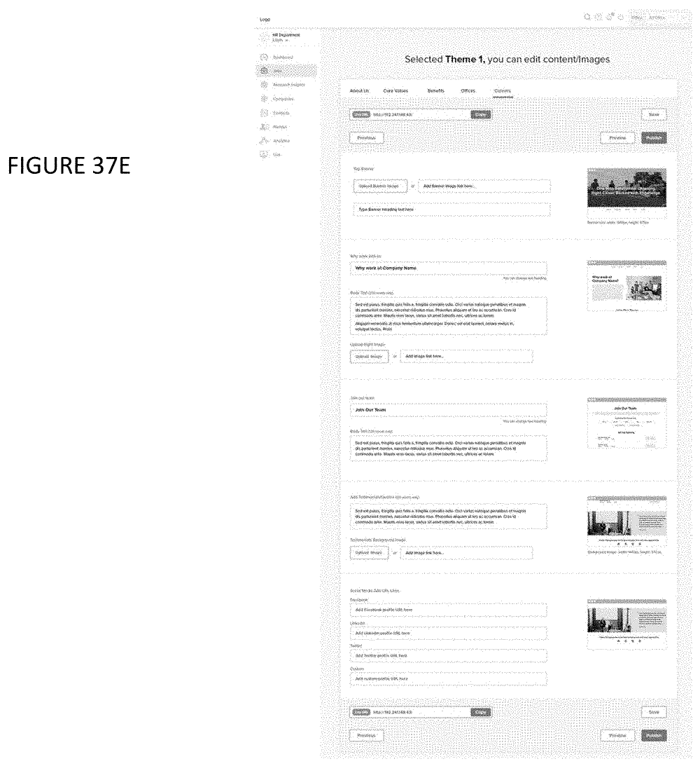

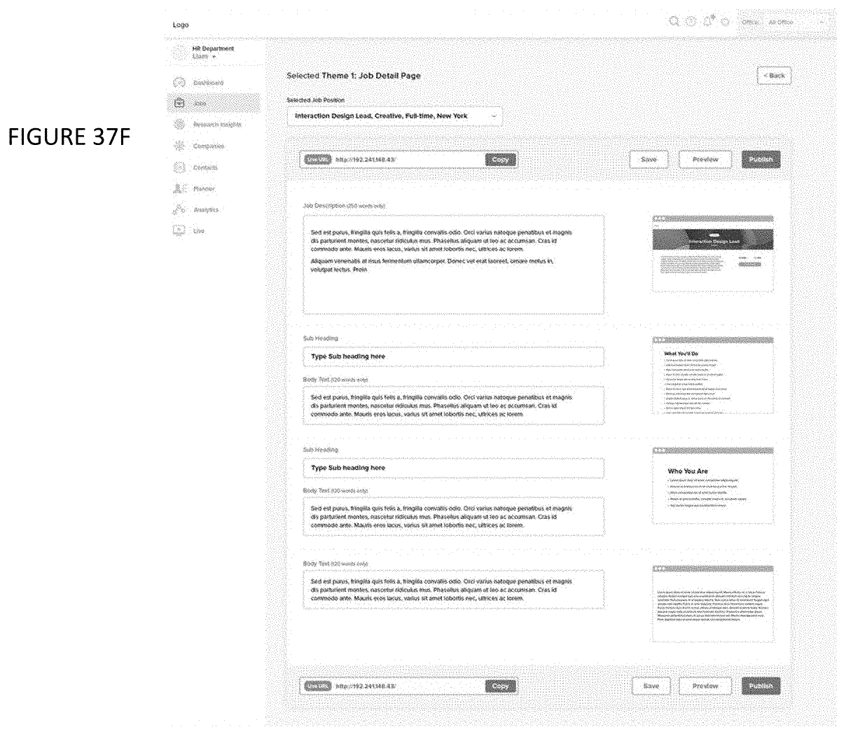

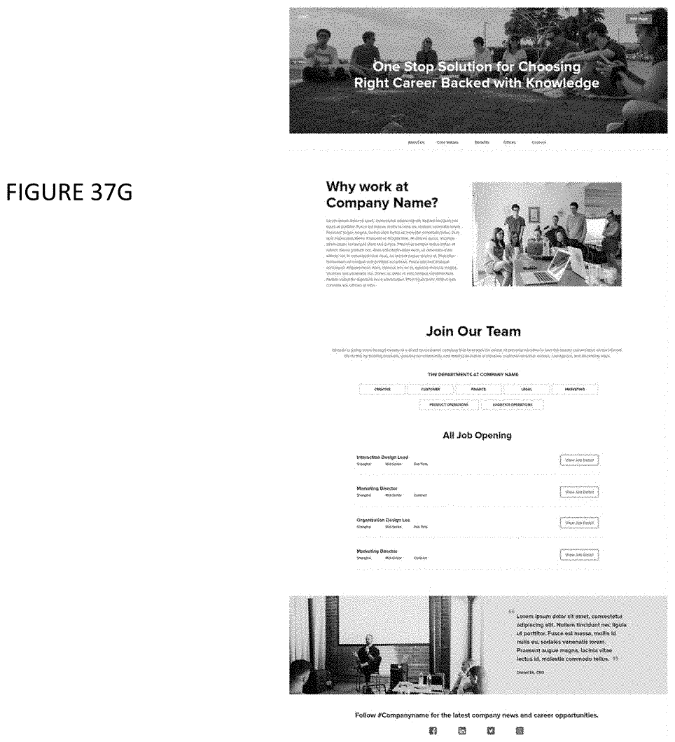

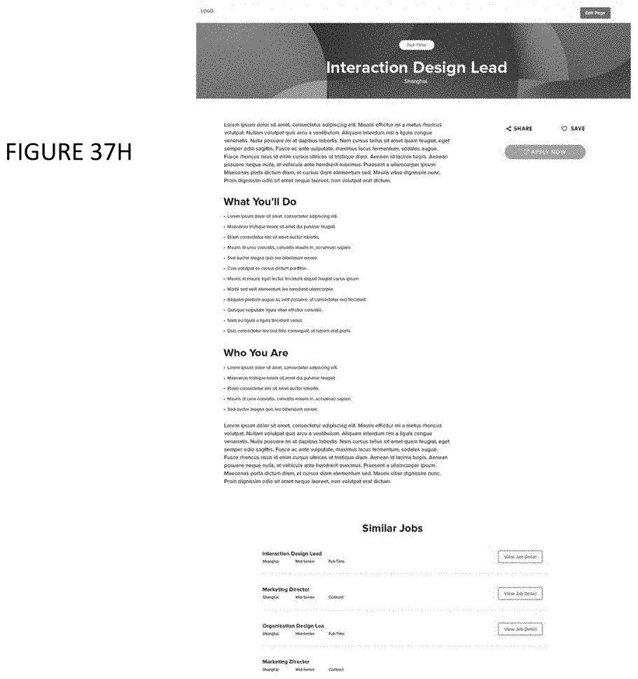

All users of the system 10 can be given access to templates to create career pages instantly and then have their applicants use internal artificial intelligence parsing technology (FIG. 37A) with a career pages module 120. Once candidates upload their resume, they no longer have to fill in any other data, as the API's can pull in education, experience, years of experience, contact information and skills, so candidates have a quick and easy application process without having to manually type beyond extra screening questions and government surveys (EEO & OFCPP) that are optionally included depending on the company that is using the system. Users can choose different themes (FIG. 37A), add information in an about us section (FIG. 37B), add information in a core values section (FIG. 37C), add information about benefits (FIG. 37D), add information about careers (FIG. 37E), and add information about job details (FIG. 37F). FIG. 37G shows a finished career page, and FIG. 37H shows a job listed on a career page. FIG. 38F is a view of filters, and FIG. 38G is a view of candidate comparison.

The system 10 also has APIs that allow recruiters to import data from their applicant tracking systems so data is not having to be entered in two systems by recruiting teams that also utilize an applicant tracking system or CRM. Applicant tracking systems manages the interview processes thereby already having core job information that would be replicated including company name, title, quantity of openings and salary range. The candidate data of who is interviewing is also capable of being imported into the system 10. The other APIs have to do with scheduling and managing tasks to be done. Having a Google and Outlook API can allow users to add tasks to their work calendars so they can plan time to complete tasks.

All of the processes shown in FIG. 1A are functional and can be created for an individual office or the data passed through the system 10 server can be in cloud data storage and compiled for multi-office functionality and franchise networks. The function allows office selection methodology on each page to select a single location for data retrieval or the option to select multiple or combined locations to view multi-location data points. Different users or markets can use different functions of the system 10 that all interconnect. For example, a metrics platform can use steps 14, 10, 26, 28, and 80 (multi-office, franchise mode). An executive search can use steps 10, 12, 14, 16, 18, 20, 22, 24, 26, 28, 80, 30, 32, and 74 (multi-office, franchise mode). A staffing platform can use steps 10, 12, 14, 16, 18, 20, 22, 24, 26, 28, 80, 30, 32, 72, and 74. An HR platform complete solution can use steps 10, 12, 14, 16, 18, 20, 22, 24, 26, 28, 80, 30, 32, 72, 74, and 76.

The software was built on PHP and a SQL database hosted in the cloud. The software delivers transparency to recruiting teams and insight for management while streamlining the research process. This software allows for many user types including managers, owners, administrators, recruiters, human resources and talent acquisition professionals, researchers, business development, full desk account executives, and assistants.

Researchers, sourcers and recruiters are required to conduct constant research in order to source talent for job openings. Daily research can consist of finding candidates at top competitors, creating job postings, searching LinkedIn in a multiple of ways utilizing Boolean techniques and search filters, searching for candidates on CareerBuilder and Monster and using a multitude of other resources.

Remembering what the recruiter did and which resources were used and effective is very hard because each of these tasks become very redundant and easily one or a multitude of the steps can be forgotten. Recruiters who are managing 5 to 20 open roles cannot remember what steps they took in each role. This has been an industry issue for way too long. In every other industry, there are many project management tools, but for the recruiting industry, there are many programs to find candidates (LinkedIn, Monster, Indeed, etc.) and manage the interview and onboarding process (Applicant Tracking systems like PCRecruiter, Taleo, Bullhorn, etc.), but there are no tools that project manage the tasks that go into the research and search process. The present invention has been created to solve this problem.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A system for managing hiring for a company, comprising a jobs database, a candidate database, a dashboard module, a key performance indicators and statistics module, a contest module, a revenue analytics module, a global knowledgebase, a task module, a payments module, a live platform, a vendor module, and an onboarding module that are in electronic communication with a user interface, said system being stored on non-transitory computer readable media.

2. The system of claim 1, wherein said user interface is chosen from the group consisting of a tablet, a smartphone, a smartwatch, a computer, and a laptop.

3. The system of claim 1, wherein said jobs database allows for new jobs to be created and displaying open jobs and archived jobs.

4. The system of claim 1, wherein said task module allows for day to day tasks to be created, managing completion of tasks, showing resources used, and showing revenue generated.

5. The system of claim 1, wherein said key performance indicators module allows for creation of key performance indicators and measuring against goals.

6. The system of claim 1, wherein said contest module allows for building contests, giving points to contest winners, and providing prizes to redeem by contest winners.

7. The system of claim 1, wherein said global knowledgebase provides for information in said system to be globally shared and reused.

8. The system of claim 1, wherein said dashboard module allows for creation of dashboards including drag and drop task lists, and displays revenue or spend produced over time in charts and graphs, snapshots of team performance, the potential revenue per each team member, contests being run, the overview of all tasks being completed in an office, and what employees have yet to do.

9. The system of claim 1, wherein said system includes global or office specific data.

10. The system of claim 1, wherein said payments module allows for recruiting firms, staffing agencies, companies, and contractors to send and receive payments via ACH or credit cards.

11. The system of claim 1, wherein said live platform allows for displaying live data to an office.

12. The system of claim 1, wherein said vendor module allows for inviting vendors, displaying registration status, and displaying esign document status.

13. The system of claim 1, wherein said onboarding module allows for uploading files to esign and displaying documents that are esigned or waiting to be esigned.

14. The system of claim 1, wherein said system allows users to set up interviews with candidates and create scorecards for interviews.

15. The system of claim 1, further including a career module for creating career pages.

16. The system of claim 1, further including a communications module for accessing email and text messages.

17. A method of managing hiring for a company, including the steps of:
a recruiter receiving a new role;
turning on an open job record in a system for managing hiring for a company stored on non-transitory computer readable media;
adding in day to day tasks in the system;
displaying open jobs or archived jobs in the system;
providing a candidates database in the system;
providing dashboards in the system;
providing customized key performance indicators and statistics in the system;
providing contests in the system;
providing a global knowledgebase in the system;
providing payments in the system; and
providing revenue analytics to a user on a user interface.

18. The method of claim 17, wherein said adding in day to day tasks step further includes managing completion of tasks, showing resources used, and showing revenue generated.

19. The method of claim 17, wherein said providing customized key performance indicators step is further defined as creating key performance indicators and measuring against goals.

20. The method of claim 17, wherein said providing contests step is further defined as building contests, giving points to contest winners, and providing prizes to redeem by contest winners.

21. The method of claim 17, wherein said providing a global knowledgebase step is further defined as providing for information in the system to be globally shared and reused.

22. The method of claim 17, wherein said providing dashboards step allows is further defined as creating dashboards including drag and drop task lists, and displaying revenue or spend produced over time in charts and graphs, snapshots of team performance, the potential revenue per each team member, contests being run, the overview of all tasks being completed in an office, and what employees have yet to do.

23. The method of claim 17, wherein said providing payments step is further defined as allowing for recruiting firms, staffing agencies, companies, and contractors sending and receiving payments via ACH or credit cards.

24. The method of claim 17, further including the step of inviting vendors, displaying registration status, and displaying esign document status.

25. The method of claim 17, further including the steps of uploading files to esign, and displaying documents that are esigned or waiting to be esigned.

26. The method of claim 17, further including the steps of setting up interviews with candidates and creating scorecards for interviews.

27. The method of claim 17, further including the step of creating career pages in the system.

28. The method of claim 17, further including the step of providing access to emails and text messages in the system.
